(19) United States
(12) Patent Application Publication
(10) Pub. No.: US 2024/0215106 A1
(43) Pub. Date: Jun. 27, 2024

(54) SIDELINK TIME DIVISION MULTIPLEX IN-DEVICE COEXISTENCE

(71) Applicant: QUALCOMM Incorporated, San Diego, CA (US)

(72) Inventors: Sherif ELAZZOUNI, San Diego, CA (US); Ozcan OZTURK, San Diego, CA (US)

(21) Appl. No.: 18/086,472

(22) Filed: Dec. 21, 2022

(51) Int. Cl. H04W 76/28; H04L 5/00; H04W 76/14; H04W 76/18; H04W 76/38

(52) U.S. Cl. CPC H04W 76/28; H04L 5/0005; H04W 76/14; H04W 76/18; H04W 76/38

(57) ABSTRACT

A device uses a first radio access technology (RAT) and a second RAT. It transmits a first signal indicative of a first sidelink (SL) discontinuous reception (DRX) pattern selected to avoid in-device coexistence (IDC) interference at the device between the RATs and receives a second signal indicative of a second SL DRX pattern obtained in view of the first SL DRX pattern and is configured according to the second SL DRX pattern. It transmits a third signal indicative of a first periodic or aperiodic SL gap selected to avoid IDC interference between the RATs. It receives a fourth signal indicative of at least one of a second periodic or aperiodic SL gap obtained in view of the first gap and is configured according to the second periodic or aperiodic SL gap. The device autonomously denies a sidelink transmission in response to the sidelink transmission prospectively causing IDC interference.

### TECHNICAL FIELD

The technology discussed below relates generally to wireless communication networks, and more particularly, to sidelink time division multiplexing (TDM) associated with in-device coexistence (IDC).

### INTRODUCTION

In wireless communication systems, such as those specified under standards for 5G New Radio (NR), WiFi, and Bluetooth, a wireless communication device (e.g., a user equipment, a UE) may operate in a dual connectivity mode. The wireless communication device may operate with multiple radio access technologies (RATs) in the dual connectivity mode. Due to the proximity and/or overlap in frequencies utilized with the various RATs, one signal associated with a first RAT may interfere with another signal associated with a second RAT. In some examples, two frequencies utilized with a first RAT, such as a first frequency associated with a master cell group and a second frequency associated with a secondary cell group, may combine, and generate intermodulation products. The intermodulation products associated with the first RAT may interfere with signals at frequencies associated with a second RAT. Such interference occurs within the closely packed confines of a wireless communication device and may be referred to as in-device coexistence interference.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a first wireless communication device is disclosed. The first wireless communication device includes a memory and a processor coupled to the memory. In the example, the processor is configured to: initiate transmission of a first signal indicative of a first sidelink (SL) discontinuous reception (DRX) pattern associated with in-device coexistence (IDC) and selected to avoid IDC interference at the first wireless communication device between wireless communications utilizing a first radio access technology (RAT) and a second RAT in a given time-frequency resource, the first RAT being associated with sidelink communication s and being different from the second RAT. The processor is further configured to receive a second signal indicative of a second SL DRX pattern obtained in view of the first SL DRX pattern in response to the transmission of the first signal, and configure the first wireless communication device according to the second SL DRX pattern.

In one example a method of wireless communication at a first wireless communication device is disclosed. The method includes transmitting a first signal indicative of a first sidelink (SL) discontinuous reception (DRX) pattern associated with in-device coexistence (IDC) and selected to avoid IDC interference at the first wireless communication device between wireless communications utilizing a first radio access technology (RAT) and a second RAT in a given time-frequency resource, the first RAT being associated with sidelink communications and being different from the second RAT. The method also includes receiving a second signal indicative of a second SL DRX pattern obtained in view of the first SL DRX pattern in response to transmitting the first signal, and configuring the first wireless communication device according to the second SL DRX pattern.

In one example a first wireless communication device is disclosed. The first wireless communication device includes a memory and a processor coupled to the memory. In the example, the processor is configured to: initiate transmission of a first signal indicative of at least one of a first periodic sidelink (SL) gap or a first aperiodic SL gap associated with in-device coexistence (IDC) and selected to avoid IDC interference at the first wireless communication device between wireless communications utilizing a first radio access technology (RAT) and a second RAT in a given time-frequency resource, the first RAT being associated with sidelink communications and being different from the second RAT. The process is further configured to receive a second signal indicative of at least one of a second periodic SL gap or a second aperiodic SL gap obtained in view of the at least one of the first periodic SL gap or the first aperiodic SL gap, respectively, in response to the transmission of the first signal, and configure the first wireless communication device according to the at least one of the second periodic SL gap or the second aperiodic SL gap, respectively.

In one example, a wireless communication device is disclosed. the wireless communication device includes a memory and a processor coupled to the memory. In the example, the processor is configured to receive a configuration that configures the wireless communication device to autonomously deny a sidelink transmission in response to the sidelink transmission prospectively causing in-device coexistence (IDC) interference.

In another example, a method of wireless communication at a first wireless communication device is disclosed. According to the example, the method includes transmitting a first signal indicative of at least one of a first periodic sidelink (SL) gap or a first aperiodic SL gap associated with in-device coexistence (IDC) and selected to avoid IDC interference at the first wireless communication device between wireless communications utilizing the first RAT and the second RAT in a given time-frequency resource, the first RAT being associated with sidelink communications and being different from the second RAT. The method also includes receiving a second signal indicative of at least one of a second periodic SL gap or a second aperiodic SL gap obtained in view of the at least one of the first periodic SL gap or the first aperiodic SL gap, respectively, in response to transmitting the first signal, and configuring the first wireless communication device according to the at least one of the second periodic SL gap or the second aperiodic SL gap, respectively.

In another example, a method of wireless communication at a wireless communication device is disclosed. In the example, the method includes receiving a configuration that configures the wireless communication device to autonomously deny a sidelink transmission in response to the sidelink transmission prospectively causing in-device coexistence (IDC) interference at the wireless communication device between wireless communications utilizing a first radio access technology (RAT) and a second RAT in a given time-frequency resource, the first RAT being associated with sidelink communications and being different from the second RAT.

These and other aspects of the disclosure will become more fully understood upon a review of the detailed description, which follows. Other aspects, features, and examples of the present disclosure will become apparent to those of ordinary skill in the art, upon reviewing the following description of specific, examples of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In a similar fashion, while any example may be discussed below in connection with a device, system, or method, it should be understood that such examples can be implemented in various devices, systems, and methods.

### BRIEF DESCRIPTION OF THE DRAWINGS

FIG. 1 is a schematic illustration of an example of a radio access network according to some aspects of the disclosure.

FIG. 2 illustrates an example of a wireless communication network configured to support sidelink communication according to some aspects of the disclosure.

FIG. 3 is a schematic illustration of an example of a disaggregated base station architecture according to some aspects of the disclosure.

FIG. 4 is an expanded view of an exemplary subframe, showing an orthogonal frequency divisional multiplexing (OFDM) resource grid according to some aspects of the disclosure.

FIG. 5 is a block diagram illustrating an example of a hardware implementation of a wireless communication device circuit board including indications of coexistence interference according to some aspects of the disclosure.

FIG. 6 is a graph illustrating an example of coexistence interference between an in-device Industrial, Science, Medical transmitter, and an Evolved Universal Terrestrial Radio Access receiver according to some aspects of the disclosure.

FIG. 7 is a schematic diagram illustrating examples of in-device coexistence issues in connection with adjacent frequency interference according to some aspects of the disclosure.

FIG. 8 is a graphical depiction of two examples of adjacent channel in-device coexistence interference in connection with a Uu interface according to some aspects of the disclosure.

FIG. 9 is a graphical depiction of an intermodulation (IMD) in-device coexistence (IDC) interference that may arise in a multi-RAT dual connectivity (MR DC) UE according to some aspects of the disclosure.

FIGS. 10A and 10B are schematic depictions of a sidelink Mode 2 scenario and a sidelink Mode 1 scenario, respectively, that may involve either or both of sidelink in licensed bands (SL) and sidelink in unlicensed bands (SL-U) according to some aspects of the disclosure.

FIG. 11 is a graph depicting long cycle lengths and long term gaps according to some aspects of the disclosure.

FIG. 12 is a call flow diagram representative of transmission via sidelink according to some aspects of the disclosure.

FIG. 13 is a graph depicting a long cycle length in connection with discontinuous reception (DRX) used in the context of sidelink communications according to some aspects of the disclosure.

FIGS. 14A and 14B are call flow diagrams depicting call flows in connection with sidelink Mode 1 and sidelink Mode 2, respectively, according to some aspects of the disclosure.

FIG. 15 is a call flow diagram representative of transmissions, via a PC-5 interface, between a Tx UE and an Rx UE operating in sidelink Mode 2 according to some aspects of the disclosure.

FIG. 16 is a call flow diagram representative of transmissions, via a PC-5 interface, between a network entity, a Tx UE, and an Rx UE operating in sidelink Mode 1 according to some aspects of the disclosure.

FIG. 17 is a block diagram illustrating an example of a hardware implementation of a wireless communication device employing a processing system according to some aspects of the disclosure.

FIG. 18 is a flow chart illustrating an example process of wireless communication, in a wireless communication network, at a wireless communication device, according to some aspects of the disclosure.

FIG. 19 is a flow chart illustrating an example process of wireless communication, in a wireless communication network, at a wireless communication device according to some aspects of the disclosure.

FIG. 20 is a flow chart illustrating an example process of wireless communication, in a wireless communication network, at a wireless communication device according to some aspects of the disclosure.

FIG. 21 is a flow chart illustrating an example process of wireless communication, in a wireless communication network, at a wireless communication device according to some aspects of the disclosure.

FIG. 22 is a block diagram illustrating an example of a hardware implementation of a network entity employing a processing system according to some aspects of the disclosure.

FIG. 23 is a flow chart illustrating an example process of wireless communication, in a wireless communication network, at a network entity according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are techniques associated with avoiding or eliminating in-device coexistence (IDC) interference that may occur with use of multi-RAT dual connectivity (MR DC) user equipment (UE). The MR DC UE (e.g., a wireless communication device) may support a first radio access technology (RAT) configured for 3GPP applications and services (e.g., sidelink) and a second RAT configured for non-3GPP applications and services (e.g., WiFi and/or Bluetooth). Examples described herein may utilize sidelink time division multiplexing (TDM) IDC reporting (e.g., indicating, identifying) in connection with the avoidance or elimination of IDC interference.

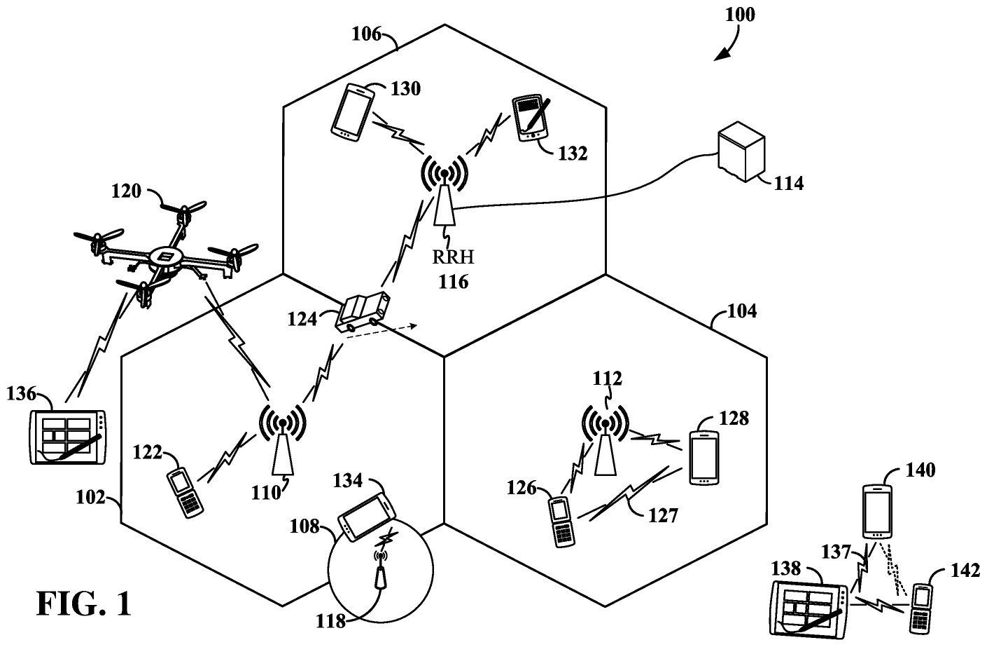

The various concepts presented throughout this disclosure may be implemented across a broad variety of telecommunication systems, network architectures, and communication standards. Referring now to FIG. 1, as an illustrative example without limitation, a schematic illustration of a radio access network (RAN) 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) (e.g., a wireless communication device) based on an identification broadcasted over a geographical area from one network entity (e.g., an access point, a base station). FIG. 1 illustrates cells 102, 104, 106, and 108, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is a network element in a radio access network responsible for radio transmission and reception in one or more cells to or from a UE. A network entity may also be referred to by those skilled in the art as a base station (BS), base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the TRPs may be an LTE base station, while another TRP may be a 5G NR base station. In some examples, a network entity may be configured in an aggregated or monolithic base station architecture or in a disaggregated base station architecture.

Various network entity (e.g., base station) arrangements can be utilized. For example, in FIG. 1, two network entities 110 and 112 are shown in cells 102 and 104; and a third network entity 114 is shown controlling a remote radio head (RRH) 116 in cell 106. That is, a network entity can have an integrated antenna or can be connected to an antenna or RRH by feeder cables. In the illustrated example, the cells 102, 104, and 106 may be referred to as macrocells, as the network entities 110, 112, and 114 support cells having a large size. Further, a network entity 118 is shown in the cell 108 which may overlap with one or more macrocells. In this example, the cell 108 may be referred to as a small cell (e.g., a microcell, picocell, femtocell, home base station, home Node B, home eNode B, etc.), as the network entity 118 supports a cell having a relatively small size. Cell sizing can be done according to system design as well as component constraints.

It is to be understood that the radio access network 100 may include any number of wireless network entities (e.g., base stations) and cells. Further, a relay node may be deployed to extend the size or coverage area of a given cell. The network entities 110, 112, 114, 118 provide wireless access points to a core network for any number of mobile apparatuses.

FIG. 1 further includes an unmanned aerial vehicle (UAV) 120, which may be a drone (e.g., a quadcopter, and octocopter, etc.). The UAV 120 may be configured to function as a network entity, or more specifically as a mobile network entity. That is, in some examples, a cell may not necessarily be stationary, and the geographic area of the cell may move according to the location of a mobile network entity such as the UAV 120.

In general, network entities may include a backhaul interface for communication with a backhaul portion (not shown) of the network. The backhaul may provide a link between a network entity and a core network (not shown), and in some examples, the backhaul may provide interconnection between the respective network entities. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as a user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with network entity 110; UEs 126 and 128 may be in communication with network entity 112; UEs 130 and 132 may be in communication with network entity 114 by way of RRH 116; UE 134 may be in communication with network entities 118; and UE 136 may be in communication with mobile network entity 120. Here, each network entity 110, 112, 114, 118, and 120 may be configured to provide an access point to a core network (not shown) for all the UEs in the respective cells. In some examples, the UAV 120 (e.g., the quadcopter) can be a mobile network entity and may be configured to function as a UE. For example, the UAV 120 may operate within cell 102 by communicating with network entity 110.

Wireless communication between a RAN 100 and a UE (e.g., UE 122 or 124) may be described as utilizing an air interface. Transmissions over the air interface from a network entity (e.g., network entity 110) to one or more UEs (e.g., UE 122 and 124) may be referred to as downlink (DL) transmission. In accordance with certain aspects of the present disclosure, the term downlink may refer to a point-to-multipoint transmission originating at a network entity (sometimes referred to as a scheduling entity) (e.g., network entity 110). Another way to describe this scheme may be to use the term broadcast channel multiplexing. Transmissions from a UE (e.g., UE 122) to a network entity (e.g., network entity on 110) may be referred to as uplink (UL) transmissions. In accordance with further aspects of the present disclosure, the term uplink may refer to a point-to-point transmission originating at a UE (sometimes referred to as a scheduled entity) (e.g., UE 122).

For example, DL transmissions may include unicast or broadcast transmissions of control information (control signaling) and/or traffic information (e.g., user data traffic) from a network entity (e.g., network entity 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to network entity 110, and for multiplexing DL or forward link transmissions from the network entity 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a network entity) allocates resources (e.g., time-frequency resources) for communication among some or all devices and equipment (e.g., UEs) within its service area or cell. Within the present disclosure, as discussed further below, the scheduling entity (e.g., the network entity) may be responsible for scheduling, assigning, reconfiguring, and releasing resources for one or more scheduled entities (e.g., UEs). That is, for scheduled communication, scheduled entities utilize resources allocated by the scheduling entity.
network entities are not the only entities that may function as a scheduling entity. That is, in some examples, a UE may function as a network entity, scheduling resources for one or more other UEs (e.g., one or more other scheduled entities). For example, two or more UEs (e.g., UEs 138, 140, and 142) may communicate with each other using sidelink signals 137 without relaying that communication through a network entity. In some examples, the UEs 138, 140, and 142 may each function as a network entity (e.g., a scheduling entity) or transmitting sidelink device and/or a UE (e.g., a scheduled entity) or a receiving sidelink device to schedule resources and communicate the sidelink signals 137 therebetween without relying on scheduling or control information from a network entity. In other examples, two or more UEs (e.g., UEs 126 and 128) within the coverage area of a network entity (e.g., network entity 112) may also communicate sidelink signals 127 over a direct link (sidelink) without conveying that communication through the network entity 112. In this example, the network entity 112 may allocate resources to the UEs 126 and 128 for the sidelink communication. In either case, such sidelink signals 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the network entity 112 via D2D links (e.g., sidelink signals 127 or 137). For example, one or more UEs (e.g., UE 128) within the coverage area of the network entity 112 may operate as relaying UEs to extend the coverage of the network entity 112, improve the transmission reliability to one or more UEs (e.g., UE 126), and/or to allow the network entity to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

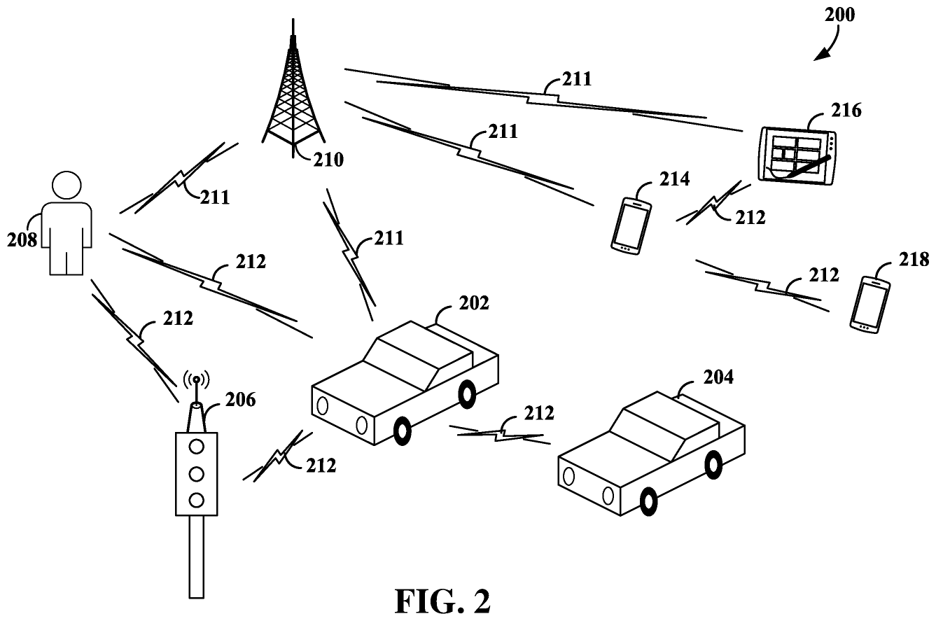

FIG. 2 illustrates an example of a wireless communication network 200 configured to support sidelink communication. In some examples, sidelink communication may include V2X communication. V2X communication involves the wireless exchange of information directly between not only vehicles (e.g., vehicles 202 and 204) themselves, but also directly between vehicles 202/204 and infrastructure (e.g., roadside units (RSUs) 206), such as streetlights, buildings, traffic cameras, tollbooths or other stationary objects, vehicles 202/204 and pedestrians 208, and vehicles 202/204 and wireless communication networks (e.g., network entity 210). The network entity 210 may be, for example, any network entity (e.g., base station, gNB, eNB, scheduling entity) as illustrated in FIG. 1. The network entity 210 may further be implemented in an aggregated or monolithic network entity architecture, or in a disaggregated network entity architecture. In addition, the network entity 210 may be a stationary network entity or a mobile network entity. In some examples, V2X communication may be implemented in accordance with the New Radio (NR) cellular V2X standard defined by 3GPP, Release 16, or other suitable standard.

V2X communication enables vehicles 202 and 204 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 202 and 204 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian or cyclist (collectively illustrated as pedestrian 208) may be utilized to trigger a warning sound, vibration, flashing light, etc., in case of imminent danger.

The sidelink communication between vehicles 202 and 204 (also referred to as—V-UEs or UEs 202 or 204) or between a vehicle 202 or 204 and either an RSU 206 or a mobile device of a pedestrian (e.g., pedestrian 208, also referred to as a P-UE or a UE 208) may occur over a sidelink 212 utilizing a proximity service (ProSe) PC5 interface. In various aspects of the disclosure, the PC5 interface may further be utilized to support D2D sidelink 212 communication in other proximity use cases. Examples of other proximity use cases may include public safety or commercial (e.g., entertainment, education, office, medical, and/or interactive) based proximity services. In the example shown in FIG. 2, ProSe communication may further occur between UEs 214, 216, and 218.

ProSe communication may support different operational scenarios, such as in-coverage, out-of-coverage, and partial coverage. Out-of-coverage refers to a scenario in which UEs are outside of the coverage area of a network entity (e.g., network entity 210), but each are still configured for ProSe communication. Partial coverage refers to a scenario in which some of the UEs are outside of the coverage area of the network entity 210, while other UEs are in communication with the network entity 210. In-coverage refers to a scenario in which UEs are in communication with the network entity 210 (e.g., gNB) via a Uu (e.g., cellular interface) connection to receive ProSe service authorization and provisioning information to support ProSe operations.

In some examples, a UE (e.g., UE 218) may not have a Uu connection with the network entity 210. In this example, a D2D relay link (over sidelink 212) may be established between UE 218 and UE 214 to relay communication between the UE 218 and the network entity 210. The relay link may utilize decode and forward (DF) relaying, amplify and forward (AF) relaying, or compress and forward (CF) relaying. For DF relaying, HARQ feedback may be provided from the receiving device to the transmitting device. The sidelink communication over the relay link may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications. NR-U operates in the 5 GHz and 6 GHz frequency bands and supports both standalone and licensed-assisted operation based on carrier aggregation and dual connectivity with either NR or LTE in the licensed spectrum. The relay link between UE 214 and UE 218 may be established due to, for example, distance or signal blocking between the network entity 210 and the UE 218, weak receiving capability of the UE 218, low transmission power of the UE 218, limited battery capacity of the UE 218, and/or to improve link diversity. Thus, the relay link may enable communication between the network entity 210 and UE 218 to be relayed via one or more relay UEs (e.g., UE 214) over a Uu wireless communication link and relay link(s) (e.g., between UE 214 and UE 218). In other examples, a relay link may enable sidelink communication to be relayed between a UE (e.g., UE 218) and another UE (e.g., UE 216) over various relay links (e.g., relay links between UEs 214 and 216 and between UEs 214 and 218).

To facilitate D2D sidelink communication between, for example, UEs 214 and 216 over the sidelink 212, the UEs 214 and 216 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 212. For example, the discovery signal may be utilized by the UE 216 to measure the signal strength and channel status of a potential sidelink (e.g., sidelink 212) with another UE (e.g., UE 214). The UE 216 may utilize the measurement results to select a UE (e.g., UE 214) for sidelink communication or relay communication.

In some examples, a common carrier may be shared between the sidelinks 212 and Uu links, such that resources on the common carrier may be allocated for both sidelink communication between UEs (e.g., UEs 202, 204, 206, 208, 214, 216, and 218) and cellular communication (e.g., uplink and downlink communication) between the UEs (e.g., UEs 202, 204, 206, 208, 214, 216, and 218) and the network entity 210. In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a network entity (e.g., network entity 210).

In addition, there may be two main resource allocation modes of operation for sidelink (e.g., PC5) communications. In a first mode, Mode 1, a network entity (e.g., gNB) 210 may allocate resources to sidelink devices (e.g., V2X devices or other sidelink devices) for sidelink communication between the sidelink devices in various manners. For example, the network entity 210 may allocate sidelink resources dynamically (e.g., a dynamic grant) to sidelink devices, in response to requests for sidelink resources from the sidelink devices. For example, the network entity 210 may schedule the sidelink communication via DCI 3_0. In some examples, the network entity 210 may schedule the PSCCH/PSSCH within uplink resources indicated in DCI 3_0. The network entity 210 may further activate preconfigured sidelink grants (e.g., configured grants) for sidelink communication among the sidelink devices. In some examples, the network entity 210 may activate a configured grant (CG) via RRC signaling. In Mode 1, sidelink feedback may be reported (e.g., indicated, identified) back to the network entity 210 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, the SCI (e.g., SCI-1 and/or SCI-2) may further include a resource assignment of retransmission resources reserved for one or more retransmissions of the sidelink transmission (e.g., the sidelink traffic/data). Thus, the SCI may include a respective PSSCH resource reservation and assignment for one or more retransmissions of the PSSCH. For example, the SCI may include a reservation message indicating the PSSCH resource reservation for the initial sidelink transmission (initial PSSCH) and one or more additional PSSCH resource reservations for one or more retransmissions of the PSSCH.

Deployment of communication systems, such as 5G new radio (NR) systems, may be arranged in multiple manners with various components or constituent parts. In a 5G NR system, or network, a network entity, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

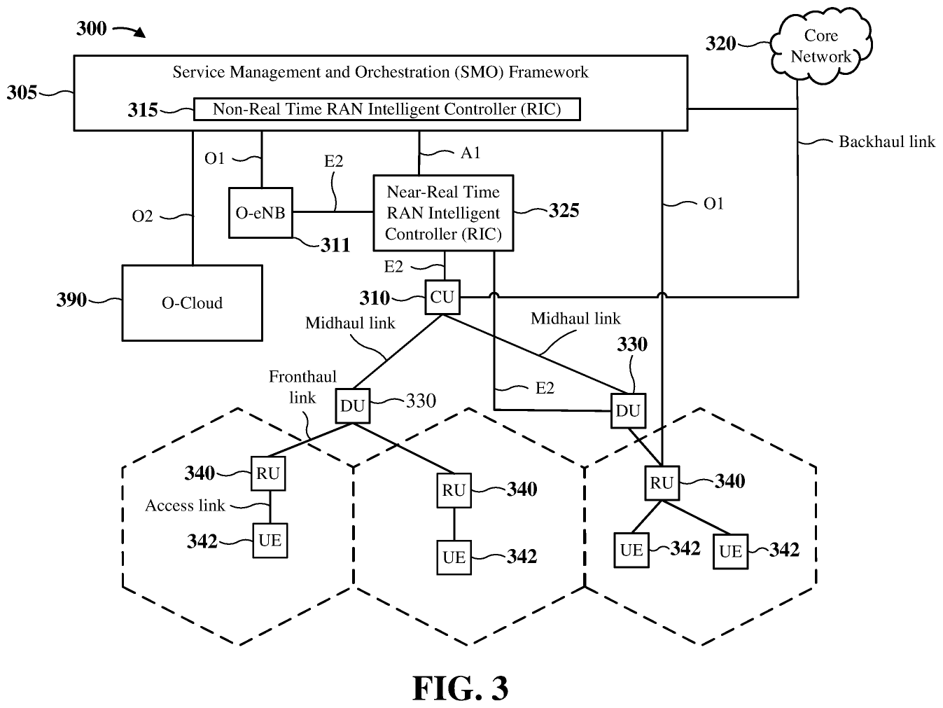

FIG. 3 is a schematic illustration of an example of a disaggregated base station 300 architecture according to some aspects of the disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 342 via one or more radio frequency (RF) access links. In some implementations, the UE 342 may be simultaneously served by multiple RUs 340. UE 342 may be the same or similar to any of the UEs or scheduled entities illustrated and described in connection with FIG. 1 and FIG. 2, for example.

Each of the units, i.e., the CUs 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 342. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

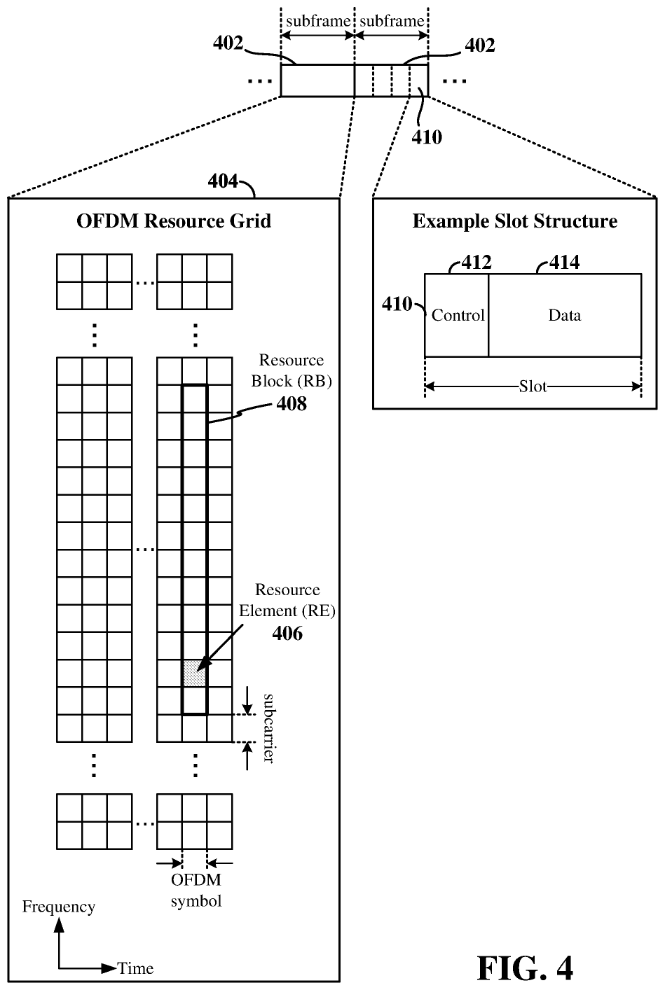

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), subband, or bandwidth part (BWP). A set of subbands or BWPs may span the entire bandwidth. Scheduling of scheduled entities (e.g., UEs) for downlink, uplink, or sidelink transmissions may involve scheduling one or more resource elements 406 within one or more subbands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a network entity (e.g., a base station, a gNB, a TRP, a scheduling entity), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a network entity) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information (e.g., a quantity of the bits of information), may be a controlled parameter, based on the modulation and coding scheme (MCS) and the number of RBs in a given transmission.

The channels or carriers described above in connection with FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

User equipment, such as UEs described and illustrated in connection with FIGS. 1-3, are designed to operate with and configured to include various 3GPP and non-3GPP radio access technologies (RATs) and geolocation technologies. UEs handling multiple 3GPP RATs may be described as having multi-RAT-dual connectivity (MR-DC) architectures. Examples of MR-DC configurations include Evolved Universal Terrestrial Radio Access (E-UTRA)—NR Dual Connectivity (EN-DC), New Radio Dual Connectivity (NR-DC), NG-RAN—E-UTRA Dual Connectivity (NGEN-DC) and NR—E-UTRA Dual Connectivity (NE-DC). Non-3GPP RATs may include, for example, WiFi, Bluetooth, and WiMAX. Examples of geolocation technologies may include the Global Positioning Satellite (GPS) system of the United States, the Bei Dou system operated by the People's Republic of China, the Galileo system operated by the European Union, and the Global Navigation Satellite System (GLONASS) operated by the Russian Federation. Each of these geolocation systems may be generically referred to a global navigation satellite system (GNSS). Accordingly, each UE may need to handle interference between 3GPP RATs, non-3GPP RATs, and GNSS type systems. Solutions to interference issues may be achieved using, for example, frequency division multiplexing techniques and/or time division multiplexing techniques. Radio resource management (RRM) techniques may be developed to address various interference issues, including, but not limited to sidelink time division multiplex (TDM) in-device coexistence (IDC) issues generally described herein.

In general, IDC issues may arise in response to the UE observing or predicting or otherwise obtaining or identifying an internal issue, or the possibility of an internal issue, caused by coexistence related to a usage of certain radio resources, which the UE cannot resolve through its own actions. In such an example, the UE may provide information to a network entity (e.g., a gNB) to elicit the assistance of the network entity in connection with avoiding the UE internal issue (or potential issue) caused by the coexistence. For example, the UE may elicit the assistance of the network entity by transmitting a request, or conveying a message, to the network entity that may cause the network entity to restrict radio resource usage.

Current IDC solutions do not support, or do not satisfactorily support, interference mitigation between 3GPP and other RATs (e.g., affected frequencies cannot be adequately indicated via a current IDC NR FDM solution). Various aspects of the disclosure relate to a TDM IDS solution, which may be utilized in various scenarios. For example, one aspect of the sidelink TDM IDC reporting (e.g., indicating, identifying) solution exemplified herein may be applicable in scenarios in which alternative non-interfered frequencies are not available. In one aspect, the sidelink TDM IDC reporting solution exemplified herein may be used to avoid interference caused by simultaneous uplink transmissions on frequencies utilized for (or near) sidelink and non-3GPP RAT UL frequencies.

Although an exemplary use case described herein may relate to interference between 3GPP and non-3GPP RATs, the scope of the disclosure is not limited to such an exemplary use case. According to some aspects, any TDM solution exemplified herein may be used in addition to or as an alternative to any current FDM solution. Accordingly, FDM and TDM solutions described herein may be complementary to one another.

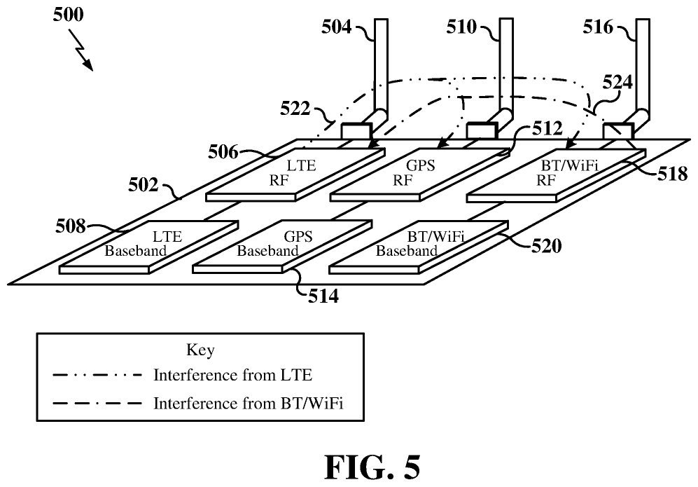

FIG. 5 is a block diagram illustrating an example of a hardware implementation of a wireless communication device circuit board 500 including indications of coexistence interference according to some aspects of the disclosure. The circuit board 500 may be housed within a housing of a wireless communication device, for example.

As depicted in FIG. 5, multiple RF transceivers may be included within one UE. A first antenna 504 may be coupled to an LTE radio frequency (RF) module/circuit 506 (here, LTE is only one example of a cellular technology; another example may be New Radio (NR)). The LTE RF module/circuit 506 may be coupled to an LTE baseband module/circuit 508. Together, the LTE RF module/circuit 506 and the LTE baseband module/circuit 508 may form an LTE transceiver that may code and modulate LTE baseband signals to higher frequency RF signals for transmission via the first antenna 504 and may receive LTE RF signals via the first antenna 504 and demodulate and decode those signals to baseband LTE signals. A second antenna 510 may be coupled to a GPS radio frequency (RF) module/circuit 512. The GPS RF module/circuit 512 may be coupled to an GPS baseband module/circuit 514. Together, the GPS RF module/circuit 512 and the GPS baseband module/circuit 514 may form a GPS receiver that may receive GPS RF signals via the second antenna 510 and demodulate and decode those signals to baseband GPS signals. A third antenna 516 may be coupled to a Bluetooth or WiFi radio frequency (RF) module/circuit 518. The Bluetooth or WiFi RF module/circuit 518 may be coupled to a Bluetooth or WiFi baseband module/circuit 520. Together, the Bluetooth or WiFi RF module/circuit 518 and the Bluetooth or WiFi baseband module/circuit 520 may form a Bluetooth or WiFi transceiver that may code and modulate Bluetooth or WiFi baseband signals to higher frequency Bluetooth or WiFi signals for transmission via the third antenna 516 and may receive Bluetooth or WiFi RF signals via the third antenna 516 and demodulate and decode those signals to baseband Bluetooth or WiFi signals.

In the example of FIG. 5, LTE in-device emissions 522 (e.g., leakage, unintentional radiation) from the LTE RF module/circuit 506 may be received by the GPS RF module/circuit 512 and/or the BT or WiFi RF module/circuit 518 and may adversely affect the performance of the GPS RF module/circuit 512 and/or the BT or WiFi RF module/circuit 518 (and/or the GPS baseband module/circuit 514 and/or the BT or WiFi baseband module/circuit 520). Similarly, BT or WiFi in-device emissions 524 from the BT or WiFi RF module/circuit 518 may be received by the LTE RF module/circuit 506 and may adversely affect the performance of the LTE RF module/circuit 506 (and/or the LTE baseband module/circuit 508).

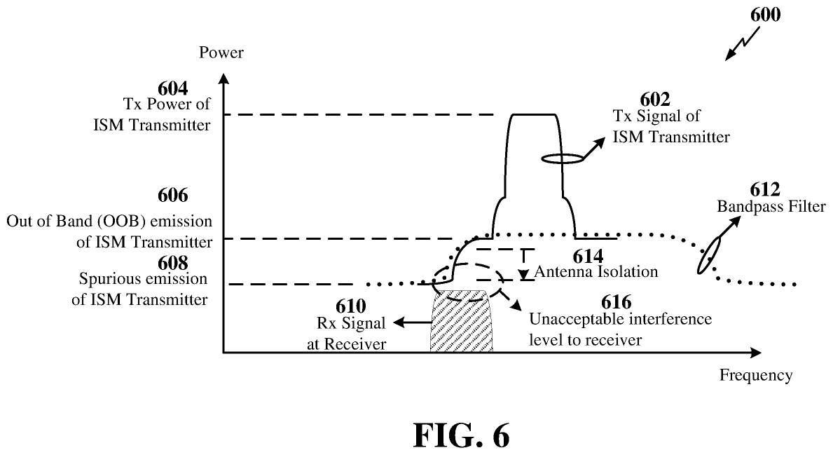

FIG. 6 is a graph illustrating an example of coexistence interference 600 between an in-device Industrial, Science, Medical (ISM) transmitter and an Evolved Universal Terrestrial Radio Access (E-UTRA) receiver, or vice versa according to some aspects of the disclosure. In the example shown in FIG. 6, frequency is illustrated along the horizontal axis and power is illustrated along the vertical axis. FIG. 6 is not drawn to scale along either axis. The example of FIG. 6 is derived from TR 36.816 v11.2.0, section 4, FIG. 4-1 (December 2011). The transmitted signal 602 of an ISM transceiver is depicted in FIG. 6. The transmitted signal 602 has a maximum transmitted power 604. The transmitted signal 602 also includes out of band (OOB) emissions 606 and spurious emissions 608. The power of the transmitted signal 602 of the ISM transmitter is depicted as being greater than the power level of a received signal 610 anticipated by a nearby E-UTRA receiver. RF filters and frequency separation may alleviate problems cause by the interference, but as depicted in FIG. 6, filters utilized by UEs having multi-RATs operating on adjacent frequencies may not provide sufficient rejection to overcome the interference. As shown in FIG. 6, the OOB emissions 606 and the spurious emissions 608 of the ISM transceiver may both fall within a bandpass 612 of a bandpass filter of the ISM transmitter. A finite amount of antenna isolation 614 may be provided between the ISM transmitter and the E-UTRA receiver. However, the OOB emissions 606 and the spurious emissions 608 of the ISM transceiver may still present an unacceptable interference level 616 to the received signal 610 at the nearby E-UTRA receiver. Accordingly, due at least to a proximity of radio transceivers of different RATs within the same UE, transmit power of one transmitter may be higher than received power of another receiver. For some coexistence scenarios, e.g., different RATs within the same UE operating on adjacent frequencies, filter technology might not provide sufficient rejection. Therefore, because solving the interference problem by single generic RF design (e.g., a bandpass filter design) may not always be possible, alternative solutions may be considered.

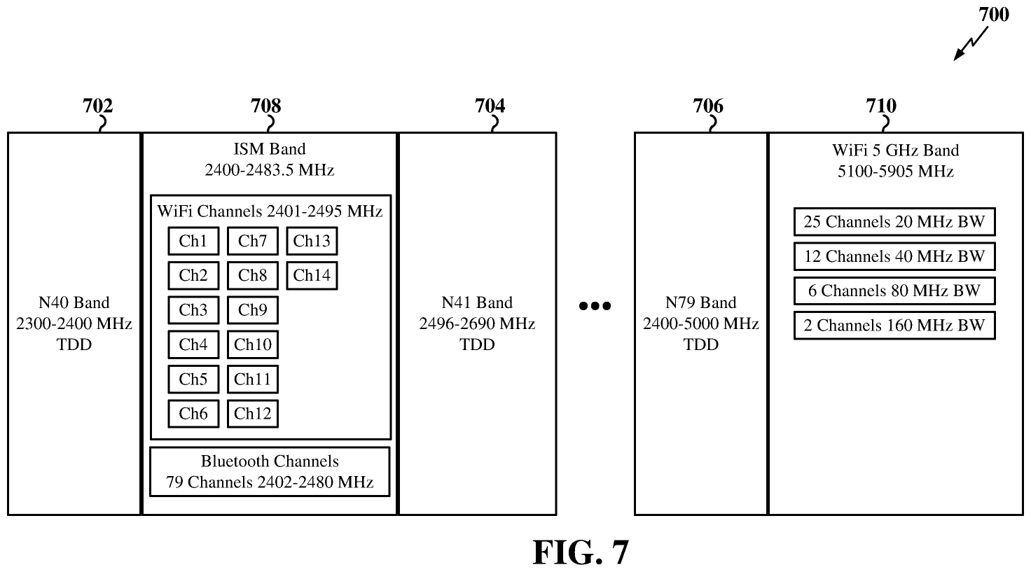

FIG. 7 is a schematic diagram illustrating examples of in-device coexistence issues in connection with adjacent frequency interference according to some aspects of the disclosure. In the example shown in FIG. 7, frequency is illustrated along the horizontal axis. FIG. 7 is not drawn to scale. In FIG. 7, the 5G NR N40 band 702 (2300-2400 MHz TDD), N41 band 704 (2496-2690 MHz TDD), and the N79 band 706 (4400-5000 MHz TDD) are depicted. Also depicted are an ISM band 708 of 2400-2483.5 MHz, including WiFi channels 1-14 (2401-2495 MHz) and 70 Bluetooth channels (2402-2480 MHz), as well as a WiFi 5 GHz band 710 (5100-5905 MHz) including 25 channels having a 20 MHz bandwidth, 12 channels having a 40 MHz bandwidth, 6 channels having an 80 MHz bandwidth, or 2 channels having a 160 MHz bandwidth. As can be recognized from FIG. 7, N40 and N41 transmission may affect WiFi reception and vice versa. N40 and N41 transmission may affect Bluetooth transmission and vice versa. N79 transmission may affect WiFi 5 GHz transmission band and vice versa. Additionally, although not shown, N13 and N14 uplink may cause interference to the L1 (GPS and GLONASS) and E1 (Galileo) GNSS frequencies due to the second harmonics associated with N13 and N14. In a further example, again not shown in FIG. 7, N7 may affect Galileo and the Indian Regional Navigation Satellite System (IRNSS). Future interfering scenarios may occur in the mmWave (e.g., sub 6 mutual interference) or in intermediate frequency (IF) (7-12 GHz)—mmWave (28 GHz) transmitter chain sharing scenarios.

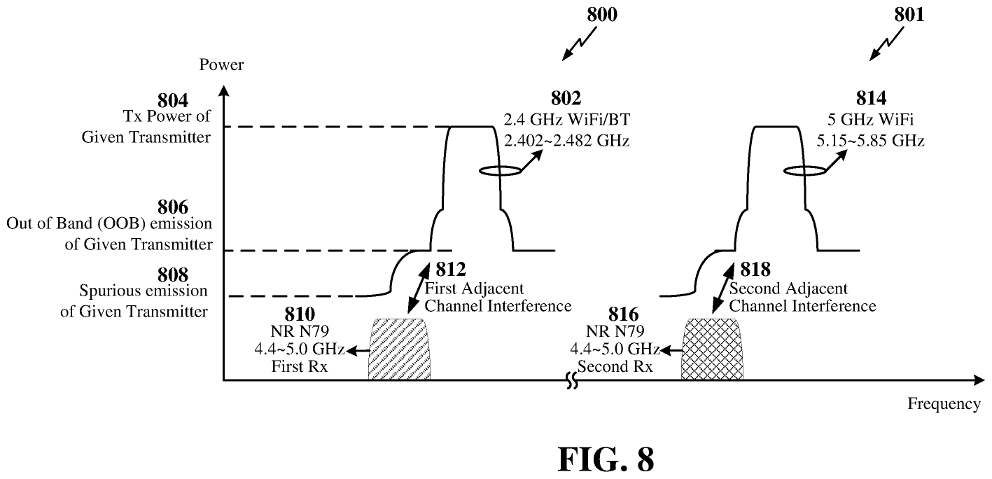

FIG. 8 is a graphical depiction of two examples of adjacent channel in-device coexistence (IDC) interference in connection with a Uu interface according to some aspects of the disclosure. In the examples shown in FIG. 8, frequency is illustrated along the horizontal axis and power is illustrated along the vertical axis. FIG. 8 is not drawn to scale along either axis. The depictions of the maximum transmitted power 804, the OOB emissions 806, and the spurious emissions 808 associated with the first transmitted signal 802 and the second transmitted signal 812, as well as the shapes of the first transmitted signal 802, the second transmitted signal 814, the first received signal 810 and the second received signal 816 are non-limiting and are identical merely for ease of illustration, and to avoid cluttering the drawing.

In a first example 800, the first transmitted signal 802 of a 2.4 GHz WiFi/BT transmitter (2.402-2.482 GHz) is depicted as having a maximum transmitted power 804. The first transmitted signal 802 includes out of band (OOB) emissions 806 and spurious emissions 808. The power level of the first transmitted signal 802 of the 2.4 GHz WiFi/BT transmitter is depicted as being greater than the power level of a first received signal 810 at an in-device NR receiver. As shown in FIG. 8, the OOB emissions 806 and the spurious emissions 808 of the 2.4 GHz WiFi/BT transmitter may both fall within the passband of the in-device NR receiver and may present an unacceptable first adjacent channel interference to the first received signal 810 at the in-device NR receiver.

In a second example 801, a second transmitted signal 814 of a 5 GHz WiFi transmitter (5.15-5.85 GHz) is depicted as having a maximum transmitted power 804. The first transmitted signal 802 includes out of band (OOB) emissions 806 and spurious emissions 808. The power level of the second transmitted signal of the 5 GHz WiFi/BT transmitter is depicted as being greater than the power level of a second received signal 816 at an in-device NR receiver. As shown in FIG. 8, the OOB emissions 806 and the spurious emissions 808 of the 5 GHz WiFi transmitter may both fall within the passband of the in-device NR receiver and may present an unacceptable second adjacent channel interference 818 to the second received signal 816 at the in-device NR receiver.

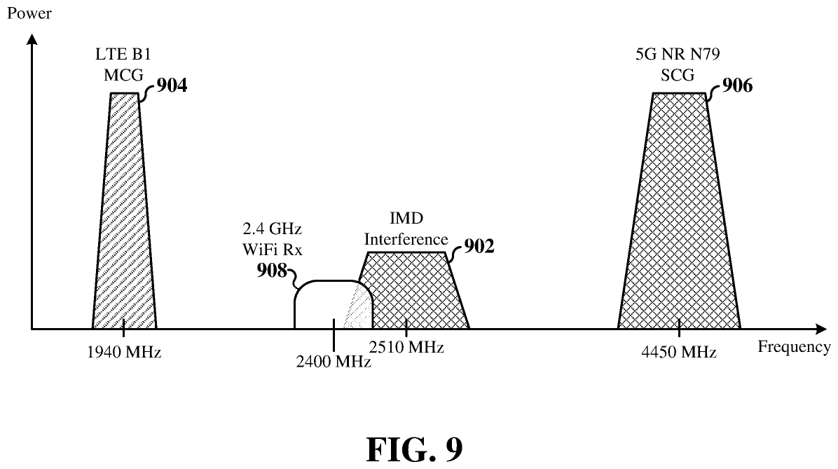

FIG. 9 is a graphical depiction of an example of intermodulation (IMD) in-device coexistence (IDC) interference that may arise in a multi-RAT dual connectivity (MR DC) UE according to some aspects of the disclosure. In the example shown in FIG. 9, frequency is illustrated along the horizontal axis and power is illustrated along the vertical axis. FIG. 9 is not drawn to scale along either axis. The depictions of the power levels of the various signals represented in FIG. 9, as well as the shapes of the various signals and the intermodulation interference are non-limiting and are merely presented as such for ease of illustration.

In the example of FIG. 9, intermodulation distortion (IMD) interference 902 (e.g., inter modulation products) may be caused by the simultaneous transmission (Tx) in the uplink within a master cell group (MCG), represented by the first waveform 904 on the left (e.g., an LTE B1 transmission at 1940 MHz), and the secondary cell group (SCG), represented by the second waveform 906 on the right (e.g., an NR N79 transmission at 4450 MHz). The MR DC example of FIG. 9 may include NR-DC and EN-DC cases. The IMD interference 902 may be caused by the non-linear combination of transmitted signals in the operational bands (B1 and N79) used during MR-DC operation, as depicted in the example. The IMD interference 902 may overlap with at least some receiver bandwidth 908 at a receiver operating using a different RAT, such as a 2.4 GHz WiFi receiver having the receiver bandwidth 908 as represented in FIG. 9, for example.

Descriptions herein include aspects that address IDC solutions not only between 3GPP technologies such as NR and LTE V2X (collectively 3GPP RATs), but also between 3GPP (e.g., NR RAT) and non-3GPP technologies (collectively non-3GPP RATs). In some examples, such as V2X, cochannel coexistence may not currently be supported because each RAT may utilize a different resource pool. In some examples associated with sidelink, two types of sidelink IDC may be described. A first type of sidelink IDC may involve simultaneous transmission (Tx/Tx) over both RATs. A second type of sidelink IDC may involve inter-RAT interference. Inter-RAT interference may appear if, for example, the LTE sidelink and the NR sidelink resource pools are not sufficiently separated in frequency and the two RATs are simultaneously utilized. According to some aspects, both types of sidelink IDC may be addressed using time division multiplexing (TDM) and/or frequency division multiplexing (FDM).

According to one long-term TDM solution, the time during which each RAT may utilize its own resources is assigned statically. The assignment (e.g., an allocation) may be pre-configured or determined by a network entity (e.g., a gNB, and eNB). According to one short-term TDM solution, each RAT may transmit or receive data in any slot or subframe of the assigned resource pool. According to this solution, LTE V2X and NR V2X may dynamically coordinate the usage of their radio resources to avoid inter-RAT interference.

In connection with V2X for example, RAT managers executable within UEs (sometimes generally referred to as RATs herein) may exchange information about the resources they intend to use, and the priority associated with this usage. For example, RAT managers may notify each other about: 1) all subframes (SFs) required for planned transmissions (i.e., reserved SFs); 2) all SFs in which a RAT manager expects to receive a transmission (i.e., all SFs with detected reservations by other vehicles); and 3) the priority of these transmissions and expected receptions (if available). With this information, the RAT managers may detect if they are both planning to be active (Tx or Rx) at the same time. If a RAT manager with a higher priority is planning to use its resources for a transmission, then the other RAT manager (with a lower priority) may not transmit or receive data at the same time. According to some examples, resolving RAT conflicts within a UE may be left to UE implementation. Presently, the short-term TDM solution may be utilized when the load of two RATs is below an acceptable level. Defining the acceptable level may avoid high performance degradation to either of the two RATs.

According to some aspects, a network entity may configure the time during which each RAT is active (and can utilize its resource pool), in scenarios where a given UE is under cellular coverage. To this aim, the given UE may indicate (e.g., report, identify) to the network entity, whether it can execute or not the short-term TDM solution. TDM solutions may help combat power and interference challenges of IDC. For example, some TDM solutions may allow one RAT to transmit at a given time. Consequently, the transmitting RAT may operate at maximum transmission power. For the same reason, these TDM solutions may prevent interference between RATs. Of course, as may be recognized, two RATs may be active simultaneously when they are both in a reception mode.

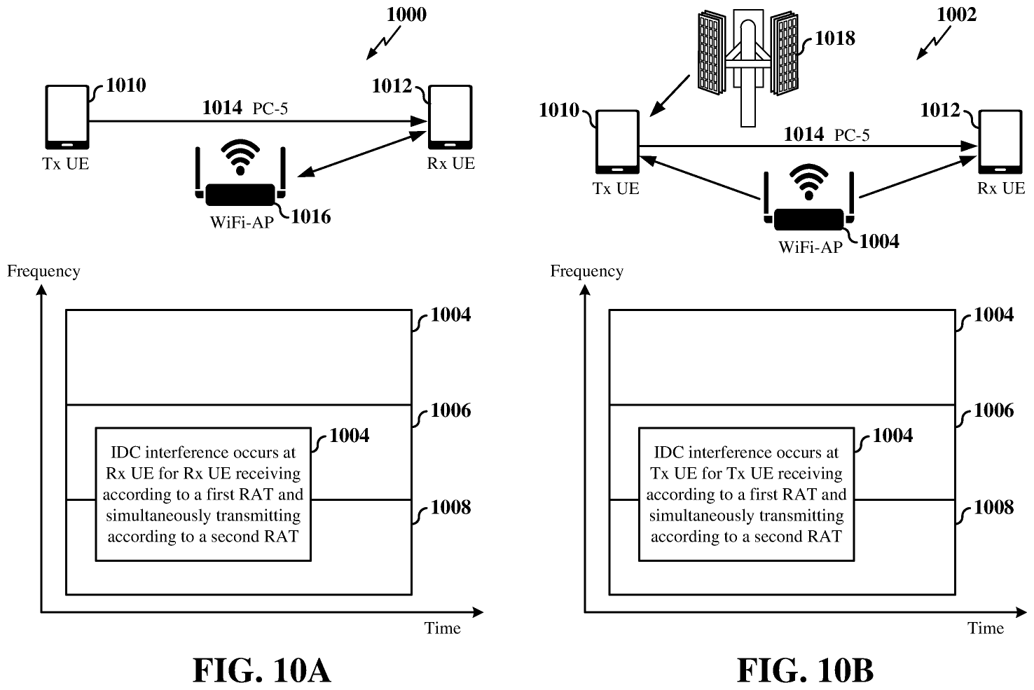

FIGS. 10A and 10B are schematic depictions of a sidelink Mode 2 scenario 1000 and a sidelink Mode 1 scenario 1002, respectively, that may involve either or both of sidelink in licensed bands (SL) and sidelink in unlicensed bands (SL-U) according to some aspects of the disclosure. In the examples of FIGS. 10A and 10B, the frequency domain is depicted with frequency illustrated along the vertical axis and time illustrated along the horizontal axis. FIGS. 10A and 10B are not drawn to scale along either axis. A first subchannel 1004, a second subchannel 1006, and a third subchannel 1008 are depicted in the frequency domain in both FIGS. 10A and 10B.

In the sidelink Mode 2 scenario 1000 (although the described scenario is also applicable to sidelink Mode 1 scenario 1002), a transmitting (Tx) UE 1010 may transmit to a receiving (Rx) UE 1012 on the second subchannel 1006 via a PC5 interface 1014 (i.e., where the PC-5 interface 1014 is utilized for sidelink communications) according to a first RAT. In connection with SL (sidelink in the licensed band), the Rx UE 1012 may not correctly receive the transmission due to IDC interference when the Rx UE 1012 is simultaneously transmitting on an adjacent frequency (e.g., within the third subchannel 1008) or the same frequency (e.g., within the second subchannel 1006), as depicted in FIG. 10A (Rx UE 1012 is simultaneously receiving a transmission via the PC-5 interface 1014 according to a first RAT and transmitting to a WiFi access point (WiFi-AP) 1016 according to a second RAT).

While still in the sidelink Mode 2 scenario 1000, but in connection with SL-U (sidelink in the unlicensed licensed band), the Rx UE 1012 may not correctly receive the transmission from the Tx UE 1010 on the second subchannel 1006 via the PC5 interface 1014 according to the first RAT due to IDC interference when the Rx UE 1012 is simultaneously receiving from another wireless communication device (e.g., WiFi-AP 1016) utilizing a second RAT on the same frequency (e.g., within the second subchannel 1006) or transmitting in the same or the adjacent channel (e.g., within the second subchannel 1006 or the third subchannel 1008, respectively), as depicted in FIG. 10A (Rx UE 1012 is simultaneously receiving a transmission via the PC-5 interface 1014 according to the first RAT and either receiving from or transmitting to the WiFi-AP 1016 according to the second RAT). In the sidelink Mode 2 scenario 1000, the described IDC interference may lead to throughput degradation and excessive retransmissions.

Turning now to the sidelink Mode 1 scenario 1002, the transmitting (Tx) UE 1010 may transmit to the receiving (Rx) UE 1012 on the second subchannel 1006 via the PC5 interface 1014 according to the first RAT on a grant scheduled by a network entity 1018 (e.g., a gNB, an eNB). In connection with SL (sidelink in the licensed band), the Tx UE 1010 may not transmit because it is attempting to receive on an adjacent band in licensed SL. While still in the sidelink Mode 1 scenario 1002, but in connection with SL-U, the Tx UE 1010 may not transmit to the Rx UE 1012 because another transmitting or receiving is taking place at the Tx UE 1010 on the second RAT. Based on these outcomes, the network entity 1018 may decode a NACK PUCCH, which counts as a lost packet, which may lead the network entity to assume the radio channel is worse than it is. The Mode 1 scenario 1002 may lead to fast degradation of capacity due to retransmissions and increased PUCCH transmissions.

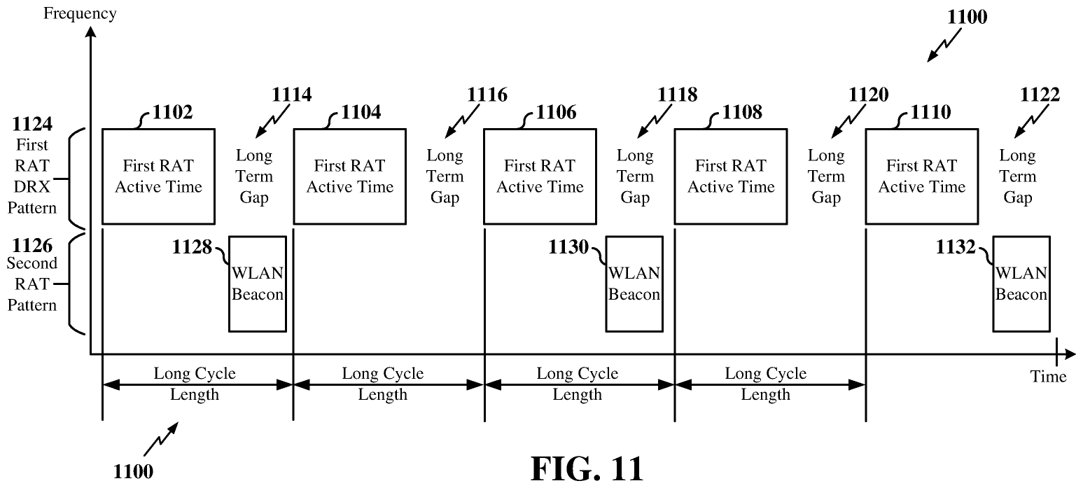

FIG. 11 is a graph depicting long cycle lengths and long term gaps according to some aspects of the disclosure. In the example of FIG. 11, the frequency-time domain is depicted with frequency illustrated along the vertical axis and time illustrated along the horizontal axis. FIG. 11 is not drawn to scale along either axis. A wireless communication device (e.g., a UE) operating in an MR DC mode may have periods of activity associated with a first RAT, for example, first RAT active times 1102, 1104, 1106, 1108, 1110 separated by long term gaps 1114, 1116, 1118, 1120, 1122. The first RAT active times 1102, 1104, 1106, 1108, 1110 may be established according to a first RAT DRX pattern 1124, for example. During the long term gaps 1114, 1116, 1118, 1120, 1122, the first RAT may not be active; however, a second RAT (e.g., a second RAT associated with a wireless local area network (WLAN)) may be utilized according to a second RAT pattern 1126. During at least some of the long term gaps (e.g., long term gaps 1114, 1118, 1122), the wireless communication device may receive, for example, WLAN beacons 1128, 1130, 1132. For example, for an Rx UE in a connected PC-5 state, the Rx UE may inform a Tx UE of a recommended or preferred DRX pattern (e.g., the first RAT DRX pattern 1124 associated with sidelink) to allow for coexistence with a second RAT (e.g., NR, WLAN, Uu) in the time domain, i.e., achieve IDC between periods of use of SL according to the first RAT and another communication technique using the second RAT, different from the first RAT. Accordingly, as used herein, a reference to a SL DRX pattern may be considered as a reference to a request for the SL DRX pattern; the SL DRX pattern may be based on an observed or predicted or otherwise obtained or identified IDC interference. According to some aspects, as illustrated in the example of FIG. 11, in-band and inter-band interference may be controlled via long-term TDM (e.g., utilizing the long cycle lengths 1100). For example, the Rx UE may separate channels to receive SL on PC5 and transmit on another RAT for another communication technology or receive SL-U on PC5 and transmit on the same band for another RAT.

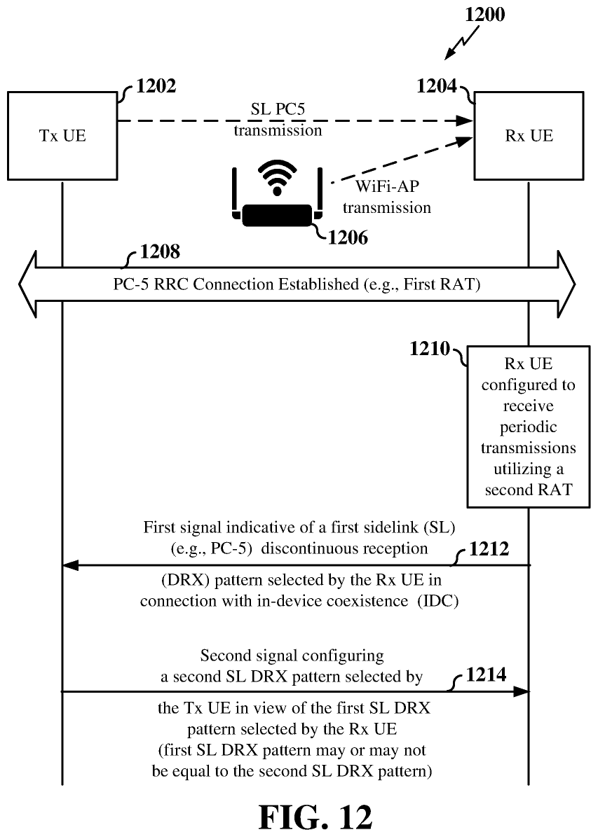

FIG. 12 is a call flow diagram 1200 representative of transmission via sidelink (e.g., a PC-5 interface) from a Tx UE 1202 to an Rx UE 1204 and transmission from a WiFi-AP 1206 to the Rx UE 1204 according to some aspects of the disclosure. Although depicted in terms of a sidelink Mode 2 scenario (e.g., as a network entity is not presented in the illustration of FIG. 12), the aspects of FIG. 12 are applicable to both sidelink Mode 1 and sidelink Mode 2. At 1208, the PC-5 RRC connection may be established utilizing a first RAT.

At 1210, the Rx UE 1204 may be configured to receive a periodic transmission (e.g., the WLAN beacons 1128, 1130, 1132 as shown and described in connection with FIG. 11) utilizing a second RAT. At 1212, the Rx UE 1204 may transmit a first signal indicative of (e.g., indicating) a first SL DRX pattern (e.g., the first RAT DRX pattern 1124 as shown and described in connection with FIG. 11) selected by the Rx UE 1204 to be utilized in connection with IDC (e.g., in connection with avoiding IDC interference). In other words, at 1212, the Rx UE 1202 may transmit a first signal indicative of a first SL DRX pattern, selected by the Rx UE 1204, to the Tx UE 1202. The selected first SL DRX pattern may be preferred by the Rx UE 1204. Accordingly, the Rx UE 1204 may be configured to transmit (or a processor of the Rx UE 1204 may be configured to initiate transmission of) a first signal indicative of a sidelink (SL) discontinuous reception (DRX) pattern associated with in-device coexistence (IDC) and selected to avoid IDC interference at the Rx UE 1204 (e.g., at the first wireless communication device) between wireless communications utilizing a first RAT and a second RAT in a given time-frequency resource, the first RAT being associated with sidelink communications and being different from the second RAT.

At 1214, the Tx UE 1202 may transmit (and the Rx UE 1204 may receive) a second signal configuring a second SL DRX pattern obtained (e.g., by the Tx UE) in view of the first SL DRX pattern preferred by the Rx UE 1204 in response to the transmission of the first signal. In obtaining the second SL DRX pattern, the Tx UE 1202 may take into consideration the first SL DRX pattern (e.g., the second SL DRX pattern may be obtained in view of the first SL DRX pattern) but may configure the Rx UE 1204 with a SL DRX pattern that is different from the first SL DRX pattern. Accordingly, the first SL DRX pattern may be the same or different from the second SL DRX pattern.

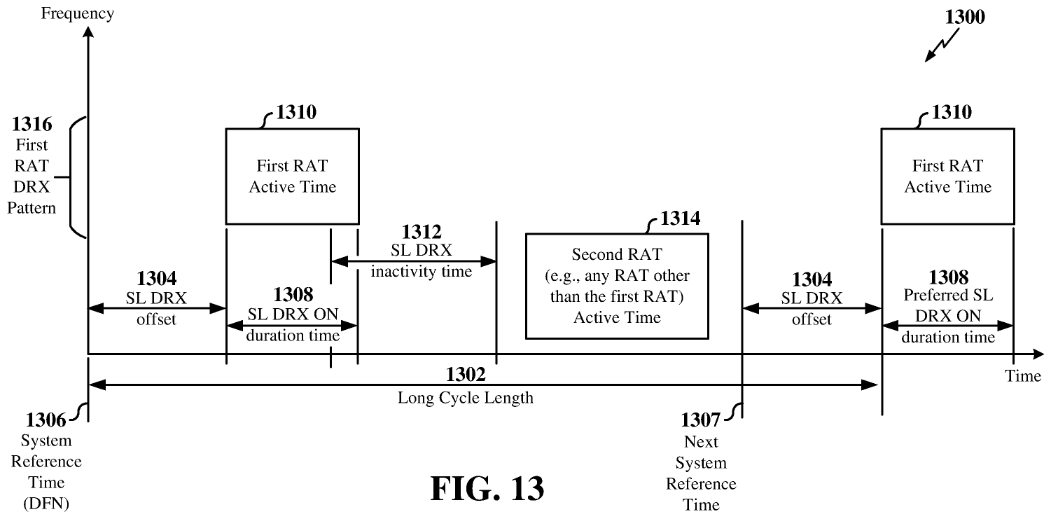

FIG. 13 is a graph depicting a long cycle length 1302 in connection with discontinuous reception (DRX) 1300 used in the context of sidelink communications according to some aspects of the disclosure. In the example of FIG. 13, the frequency-time domain is depicted with frequency illustrated along the vertical axis and time illustrated along the horizontal axis. FIG. 13 is not drawn to scale along either axis.

In the example of FIG. 13, an SL DRX offset 1304 (as measured in time) may be defined relative to a system reference time 1306 (e.g., as identified by a direct frame number (DFN)). The SL DRX offset 1304 may be an SL DRX offset that is selected (e.g., preferred) by an Rx UE (e.g., similar to the Rx UE 1204 as shown and described in connection with FIG. 12). At the SL DRX offset 1304, an SL DRX ON duration timer (not shown) may be started and may run for an SL DRX ON duration time 1308. The SL DRX ON duration time 1308 may be selected by the Rx UE.

A first RAT active time 1310 (e.g., similar to the first RAT active time 1102 as shown and described in connection with FIG. 11) may exist at least until the expiration of the SL DRX ON duration timer, at the expiry of the SL DRX ON duration time 1308. Before the expiry of the SL DRX ON duration timer (e.g., before expiry of the SL DRX ON duration time 1308), the Rx UE may receive a first RAT communication. In other words, while the SL DRX ON duration timer is running, the Rx UE may receive and/or transmit one or more first RAT communications.

In association with reception (and/or transmission) of the first RAT communication during the first RAT active time 1310, an SL DRX inactivity timer (not shown) may be started and may run for an SL DRX inactivity time 1312. According to some aspects, during the SL DRX inactivity time 1312, the Rx UE may remain configured to receive, for example, a first RAT communication even after the SL DRX ON duration time 1308 has ended. According to such aspects, the SL DRX inactivity time 1312 may not be a time during which the first RAT is OFF (and unable to receive and/or transmit a first RAT communication), but instead may be a time during which the first RAT may remain ON and may remain configured to receive and/or transmit a first RAT communication. According to such aspects, the SL DRX inactivity time 1312 may be different from a first RAT inactive or OFF time.

For example, FIG. 13 depicts the first RAT active time 1310 as having a definite duration, corresponding to the SL DRX ON duration time 1308 (and measured by an SL DRX ON duration timer (not shown)). A first RAT communication may be at least one of: received, or transmitted during the SL DRX ON duration time 1308. In association with the at least one of: the received, or the transmitted first RAT communication, the Rx UE may set an SL DRX inactivity timer (not shown) for a duration equal to the SL DRX inactivity time 1312. According to one example, the Rx UE may select (e.g., recommend, indicate a preference) a short enough SL DRX inactivity time 1312 to cause (e.g., ensure with high probability) the SL DRX ON duration time (e.g., the SL DRX ON duration time 1308 associated with the first RAT active time 1310) to end before a transmission of a second RAT begins. As used herein, reference to a second RAT may be a reference to any RAT that is different from the first RAT. It will be understood that aspects described herein are not limited to only two RATs; only two RATS are illustrated to avoid cluttering the drawing.

FIG. 13 depicts a second RAT active time 1314 during which a second RAT may be active. The duration and positioning of the second RAT active time 1314 is exemplary and non-limiting. In one example, the Rx UE may select the SL DRX inactivity time 1312 to be short enough to cause (e.g., force) a Tx UE (where the Tx UE transmits a signal to the Rx UE) to transmit within the ON duration (e.g., within the SL DRX ON duration time 1308) including the SL DRX inactivity time 1312. According to some aspects, the Rx UE may select the SL DRX inactivity time 1312 to be short enough to avoid having the Rx UE being in an ON duration during a second RAT transmission (e.g., during the second RAT active time 1314). Having the Rx UE in an ON duration during the second RAT transmission may waste power, considering, for example, that the Rx UE cannot functionally receive during the time the second RAT is transmitting; accordingly, having the first RAT active while the second RAT is transmitting may waste (e.g., dissipate) power during the ON duration. FIG. 13 graphically depicts, for purposes of example and not limitation, an overlap between the SL DRX ON duration time 1308 and the SL DRX inactivity time 1312. The overlap is exemplary and non-limiting.

At the end of another SL DRX offset 1304, as measured in time from a next system reference time 1307, another first RAT active time 1310 may occur for a duration at least equal to the SL DRX ON duration time 1308. As depicted in FIG. 12, the long cycle length 1302 may span between the first system reference time 1306 and the SL DRX offset following the next system reference time 1307. The Rx UE may select a next SL DRX inactivity time (not shown), which may be the same or different from the earlier SL DRX inactivity time 1312, for example.

As described above in connection with the example of FIG. 13, the Rx UE may use an inactivity timer to ensure (e.g., with high probability) that the ON duration (e.g., the first RAT active time 1310) ends before a transmission of a second RAT begins. According to one example, the Rx UE may use a new information element, such as an SL-PreferredDRX-InactivityTimer information element, to communicate the SL DRX inactivity time to the Tx UE. According to one aspect, the Rx UE may incorporate IDC information, including for example the SL DRX inactivity time 1312, with SL DRX offset information. It may be left to the Rx UE implementation to balance IDC requirements and other considerations such as UE power. According to another aspect, a first RAT DRX pattern 1316 associated with IDC may be signaled (e.g., via an information element) from the Rx UE to the Tx UE. In some examples, the first RAT DRX pattern 1316 (e.g., an SL DRX pattern associated with IDC) may be signaled per subchannel because not all subchannels may need to perform TDM IDC. For instance, a Bluetooth band may use a small bandwidth and may cause interference with just one or two subchannels (out of a greater number of subchannels). In such an instance, signaling DRX for an entire resource pool may be wasteful. In conjunction with the signaling (e.g., via an information element) of the first RAT DRX pattern 1316 (e.g., an SL DRX pattern) associated with IDC, the Rx UE may also indicate (e.g., report, identify) whether the first RAT DRX pattern is associated with interference form a given interface (e.g., an LTE S interface or an NR Uu interface), for example, or due to interference from another system, by adding a systemType field in the DRX reporting signaling, for example.

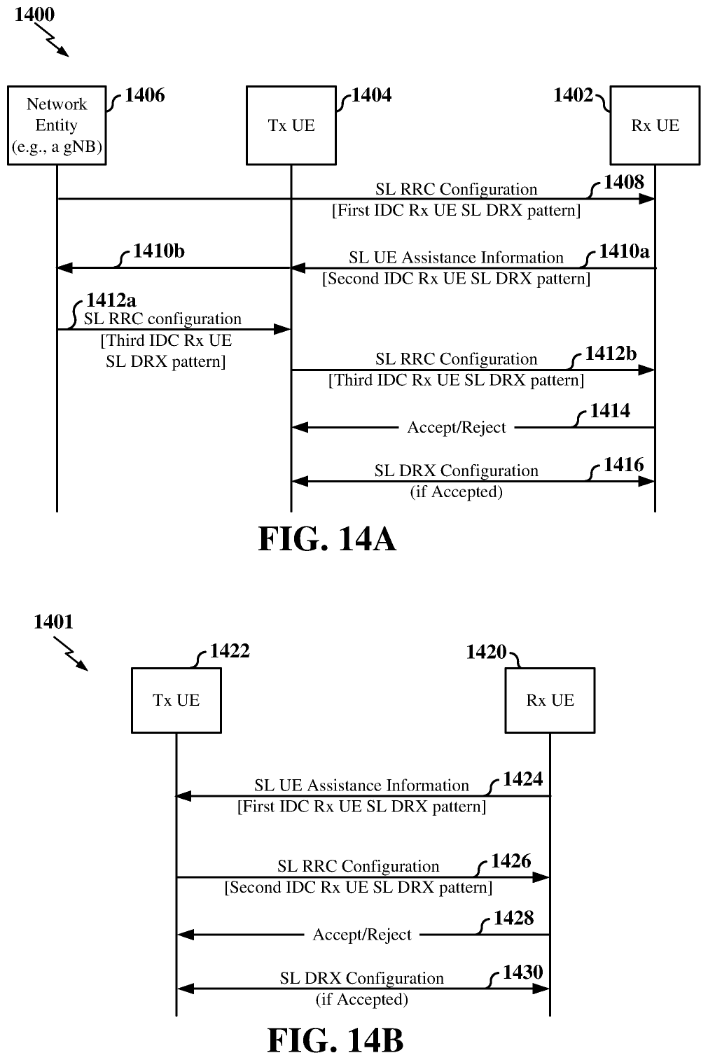

FIGS. 14A and 14B are call flow diagrams depicting call flows in connection with SL Mode 1 1400 and SL Mode 2 1401, respectively, according to some aspects of the disclosure. In connection with FIGS. 14A and 14B, SL DRX patterns may be expressed on a per-frequency band, a per-resource pool, or a per-bandwidth part basis. In FIG. 14A, a network entity 1406 (e.g., an aggregated or disaggregated base station, a gNB) may, at 1408, configure a first IDC Rx UE SL DRX pattern (e.g., a first SL DRX pattern associated with IDC) to an Rx UE 1402. The first IDC Rx UE SL DRX pattern may be an IDC SL DRX pattern that is preferred by the network entity 1406. The operation at 1408 may be optional according to some aspects. The first IDC Rx UE SL DRX pattern may be similar to the first RAT DRX pattern 1124 or the first RAT DRX pattern 1316, as shown and described in connection with FIG. 11 or FIG. 13, respectively.

At 1410a, the Rx UE 1402 may transmit SL UE assistance information (SL UAI) indicative of a second IDC Rx UE SL DRX pattern (e.g., a second SL DRX pattern associated with the IDC) selected (e.g., desired, preferred) by the Rx UE 1402. The second IDC Rx UE SL DRX pattern selected by the Rx UE 1402 at 1410a may be obtained in view of (e.g., following an evaluation of, after considering, based on) the first IDC Rx UE SL DRX pattern that is preferred by the network entity 1406 but may be different from the first IDC Rx UE SL DRX pattern that is preferred by the network entity 1406. At 1410b, the Tx UE 1404 may transmit (e.g., may forward) the SL UE assistance information indicative of the second IDC Rx UE SL DRX pattern selected by the Rx UE 1402 to the network entity 1406.

At 1412a, the network entity 1406 may convey, via RRC signaling for example, a third IDC Rx UE SL DRX pattern (e.g., a third SL DRX pattern associated with IDC) to the Tx UE 1404. The third IDC Rx UE SL DRX pattern may be the same or different as, and may be obtained in view of, either the first IDC Rx UE SL DRX pattern or the second IDC Rx UE SL DRX pattern. At 1412b, the Tx UE 1404 may forward, via RRC signaling for example, the third IDC Rx UE SL DRX pattern (e.g., a SL RRC configuration) to the Rx UE 1402.

At 1414, the Rx UE 1402 may accept or reject the third IDC Rx UE SL DRX pattern conveyed from the network entity 1406 to the Rx UE 1402 via the Tx UE 1404. At 1416, if the third IDC Rx UE SL DRX pattern transmitted from the network entity 1406 to the Rx UE 1402 via the Tx UE 1404 was accepted at 1414, the Rx UE may implement the SL RRC configuration and receive and/or transmit according to the third IDC Rx UE SL DRX pattern.

In FIG. 14B, an Rx UE 1420, at 1424, may transmit SL UE assistance information indicative of a first IDC Rx UE SL DRX pattern (e.g., a first SL DRX pattern associated with the IDC) selected (e.g., desired, preferred) by the Rx UE 1420 to a Tx UE 1422. The first IDC Rx UE SL DRX pattern may be similar to the first RAT DRX pattern 1124 or the first RAT DRX pattern 1316 as shown and described in connection with FIG. 11 or FIG. 13, respectively. According to some aspects, the first IDC Rx UE SL DRX pattern may be expressed on a per-frequency band, a per-resource pool, or a per-bandwidth part basis.

At 1426, the Tx UE 1422 may convey, via RRC signaling for example, a configuration of a second IDC Rx UE SL DRX pattern (e.g., a second SL DRX pattern associated with IDC) (e.g., a SL RRC configuration) to the Rx UE 1420. According to some aspects, the second IDC Rx UE SL DRX pattern may be selected by the Tx UE 1422 in view of (e.g., following an evaluation of, after considering, based on) the first IDC Rx UE SL DRX pattern. The second IDC Rx UE SL DRX pattern may be the same as or different from the first IDC Rx UE SL DRX pattern selected by the RX UE 1420 as identified at 1424.

At 1428, the Rx UE 1420 may accept or reject the second IDC Rx UE SL DRX pattern conveyed from the Tx UE 1422. At 1430, if the second IDC Rx UE SL DRX pattern transmitted from the Tx UE 1422 was accepted at 1428, the Rx UE may implement the SL RRC configuration and receive and/or transmit according to the second IDC Rx UE SL DRX pattern configured at the Rx UE 1420.

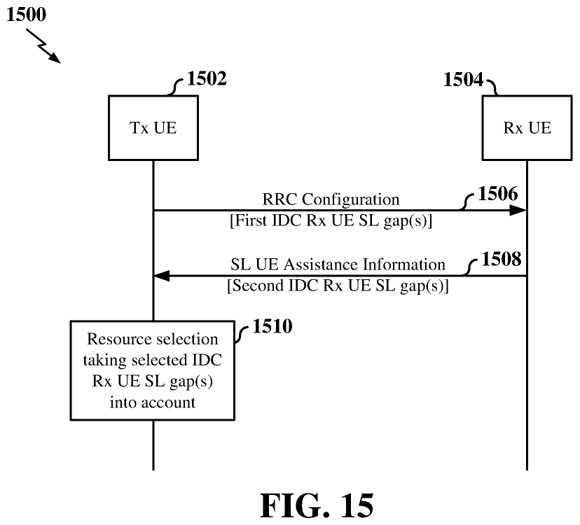

FIG. 15 is a call flow diagram 1500 representative of transmissions, via a PC-5 interface (e.g., sidelink), between a Tx UE 1502 and an Rx UE 1504 operating in SL Mode 2 according to some aspects of the disclosure. In connection with FIG. 15, SL gap(s) associated with IDC (e.g., IDC Rx UE SL gap(s)) may be expressed on a per-frequency band, a per-resource pool, or a per-bandwidth part basis. Additionally, information associated with the IDC Rx UE SL gap(s) may include instructions to setup or release the gap(s) for periodic SL gap(s) and/or aperiodic SL gap(s).

At 1506, the Tx UE 1504 may, via PC-5 signaling, convey an RRC configuration, for example, to report (e.g., indicate, identify) first IDC Rx UE SL gap(s) (e.g., SL gap(s) associated with IDC) for use by the Rx UE 1504, to the Rx UE 1504. As used herein, a reference to a SL gap(s) may be considered as a reference to a request for the SL gap(s); the SL gap(s) may be based on an observed or predicted or otherwise obtained or identified IDC interference. The first IDC Rx UE SL gap(s) may be selected by the Tx UE 1502 and may be preferred or desired by the Tx UE 1502. The aspects at 1506 may be optional according to some aspects of the disclosure.

At 1508, the Rx UE 1504 may convey, via SL UE assistance information for example, a second IDC Rx UE SL gap(s) (e.g., SL gap(s) associated with IDC) selected by the Rx UE 1504 to the Tx UE 1502. According to some aspects, the second IDC Rx UE SL gap(s) may be selected by the Rx UE 1504 in view of (e.g., following an evaluation of, after considering, based on) the first IDC Rx UE SL gap(s) (received at the Rx UE 1504 at 1506). The second IDC Rx UE SL gap(s) may be the same as or different from the first IDC Rx UE SL gap(s). At 1510, the Tx UE 1502 may perform resource selection taking the second IDC Rx UE SL gap(s) into account. For example, the Tx UE 1502 may avoid scheduling grants for resources that overlap with the second IDC Rx UE SL gap(s).

Accordingly, in some aspects, the Rx UE 1504 may select (e.g., indicate a desire or need for) a periodic SL gap or aperiodic SL gap and convey details regarding the periodic SL gap or aperiodic SL gap to Tx UE 1502 to ensure that the Tx UE 1502 does not schedule transmissions within the period of (e.g., during the duration of) the gap. For SL Mode 2, Rx UE 1504 may indicate this SL gap to Tx UE 1502 as part of SL UE assistance information, for example. It is noted that implementation of the SL gap aspect is distinct and separate from the previously described SL DRX pattern associated with IDC process aspects.

As illustrated at 1506, the Tx UE 1502 may explicitly configure the SL gap at the Rx UE 1504 via PC-5 RRC configuration. As indicated above, the operation at 1506 may be optional according to some aspects of the disclosure. Accordingly, if the RRC configuration at 1506 is optional and not implemented, then at 1508, the Rx UE 1504 may send the SL gap information to the Tx UE 1502 without having been previously RRC configured to the Rx UE 1504 by the Tx UE 1502.

According to another aspect associated with SL UE assistance information (UAI), the SL gap information may be exchanged between the Rx UE 1504 and the Tx UE 1502 and a UE coordinator via Inter-UE Coordination (IUC) signaling (not shown). It is noted that the UE coordinator may be the Rx UE 1504 or a third UE (not shown) with knowledge of the SL gap information.

According to another aspect, the Rx UE 1504 may groupcast the SL gap information to potential Tx UEs (e.g., including Tx UE 1502). It may be left to the potential Tx UE's implementation to perform resource selection on resources that are not overlapped with the gap(s) identified in the SL gap information.

According to still another aspect, the SL gap(s) may be specified on a per-frequency band, a per-resource pool, or a per-SL bandwidth part basis to indicate the frequencies where the SL gap(s) associated with IDC occur. The SL gap(s) may occur at frequencies were IDC interference may exist.

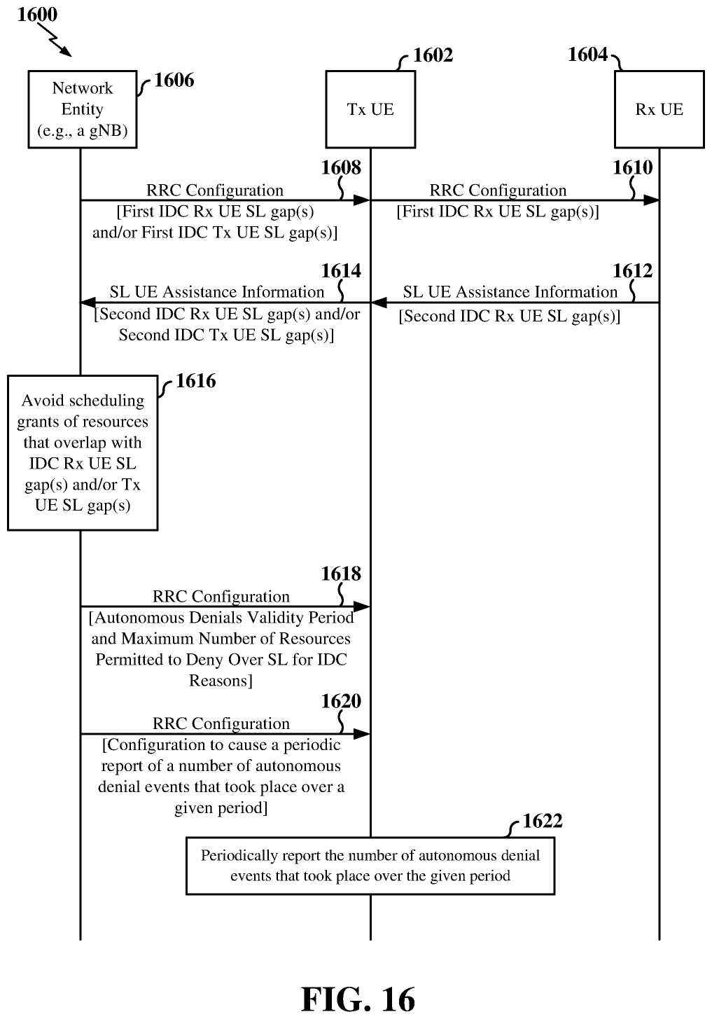

FIG. 16 is a call flow diagram 1600 representative of transmissions, via a PC-5 interface, between a network entity 1606 (e.g., a gNB), a Tx UE 1602, and an Rx UE 1604 operating in SL Mode 1 according to some aspects of the disclosure. In connection with FIG. 16, SL gap(s) associated with IDC (e.g., IDC Rx UE SL gap(s) and/or IDC Tx UE SL gap(s)) may be expressed on a per-frequency band, a per-resource pool, or a per-bandwidth part basis. Additionally, information associated with the IDC Rx UE SL gap(s) and/or IDC Tx UE SL gap(s) may include instructions to setup or release the gap(s) for periodic SL gap(s) and/or aperiodic SL gap(s).

At 1608, the network entity 1606 may, via PC-5 signaling, convey an RRC configuration, for example, to report (e.g., indicate, identify) first IDC Rx UE SL gap(s) and/or first IDC Tx UE SL gap(s) to the Tx UE 1602. At 1610, the Tx UE 1602 may use an RRC configuration obtained from the network entity 1606, for example, to report the first IDC Rx SL gap(s) to the Rx UE 1604. The first IDC Rx UE SL gap(s) and/or the first IDC Tx UE SL gap(s) may be selected by the network entity 1606 and may be preferred or desired by the network entity 1606. The aspects described at 1608 and 1610 may be optional according to some aspects of the disclosure.

At 1612, the Rx UE 1604 may convey, via SL UE assistance information for example, a second IDC Rx UE SL gap(s) to the Tx UE 1602. According to some aspects, the second IDC Rx UE SL gap(s) may be selected by the Rx UE 1604 in view of (e.g., following an evaluation of, after considering, based on) the first IDC Rx UE SL gap(s). The second IDC Rx UE SL gap(s) may be desired or preferred by the Rx UE 1604. The second IDC Rx UE SL gap(s) may be the same as or different from the first IDC Rx UE SL gap(s). At 1614, the Tx UE 1602 may convey, via SL UE assistance information for example, the second IDC Rx UE SL gap(s) received from the Rx UE 1604 and/or second IDC Tx UE SL gap(s) to the network entity 1606. According to some aspects, the second IDC Tx UE SL gap(s) may be selected by the Tx UE 1602 in view of the first IDC Tx UE SL gap(s). The second IDC Tx UE SL gap(s) may be desired or preferred by the Tx UE 1602. The second IDC Tx UE SL gap(s) may be the same as or different from the first IDC Tx UE SL gap(s). At 1616, the network entity 1606 may perform resource selection taking the second IDC Rx UE SL gap(s) and/or the second IDC Tx UE SL gap(s) into account. For example, the network entity 1606 may avoid scheduling grants for resources that overlap with the second IDC Rx UE SL gap(s) and/or the second IDC Tx UE SL gap(s).

Accordingly, in Mode 1, the Tx UE 1602 may, according to some aspects, inform the network entity 1606 of selected (e.g., requested, desired, preferred) SL gap(s) of either of both the Tx UE 1602 and the Rx UE 1604. According to some aspects, the SL gap(s) may be signaled separately or may be combined in association with reporting the SL gap(s) utilizing RRC configuration from the network entity 1606 at 1608, for example, or utilizing the SL UE assistance information (SL UAI) signaling to the network entity 1606 at 1614, for example. According to some aspects, the reporting may be configured by the network entity 1606 via RRC configuration.

According to still another aspect in connection with Mode 1 may be an autonomous denial SL solution to IDC interference. According to such an aspect, the Tx UE 1602 may be configured to deny a SL transmission for IDC purposes. The aspect of autonomous denial SL solution to IDC interference is illustrated in FIG. 16; however, it will be understood that aspects of SL gap(s) associated with IDC as shown and described in at 1608-1616 are not prerequisites for, and may exist independently from, the aspect of autonomous denial SL solution to IDC interference as shown and described at 1618-1622.

According to one aspect of autonomous denial of communication over sidelink in connection with IDC interference, a network (e.g., via the network entity 1606) may configure an autonomous denials validity period and a maximum number of resources that a Tx UE may be permitted to deny over SL for IDC reasons. Accordingly, at 1618, the network entity (e.g., network entity 1606 as shown and described in connection with FIG. 16) may transmit and RRC configuration to report (e.g., indicate, identify) an autonomous denials validity period and a maximum number of resources that a Tx UE may be permitted to deny over SL for IDC reasons. However, the network entity 1606 may be unable to determine whether an autonomous denial event or a radio link loss caused a PUCCH NACK, for example. Accordingly, at 1618, the network entity may transmit an RRC configuration to configure the Tx UE 1602 to periodically report a number (e.g., a quantity) of autonomous denial events that took place over a given period. The reporting may be via a MAC CE or RRC signaling, for example. The periodic reporting by the Tx UE 1602 may prevent the network entity 1606 from erroneously estimating a higher error rate over the SL, where the higher error rate could limit SL capacity. At 1622, in response to receiving the RRC configuration at 1620, the Tx UE 1602 may periodically report the number of autonomous denial events that took place over the given period (to the network entity 1606).

Described herein are techniques associated with avoiding or eliminating in-device coexistence (IDC) interference that may occur in connection with multi-RAT dual connectivity (MR DC) user equipment. The MR DC UE may include a first RAT configured for 3GPP applications and services (e.g., sidelink) and a second RAT configured for non-3GPP applications and services (e.g., WiFi and/or Bluetooth) (e.g., the second RAT may be any RAT that is different from the first RAT). Examples described herein may utilize sidelink time division multiplexing (TDM) IDC reporting in connection with avoiding or eliminating IDC interference.

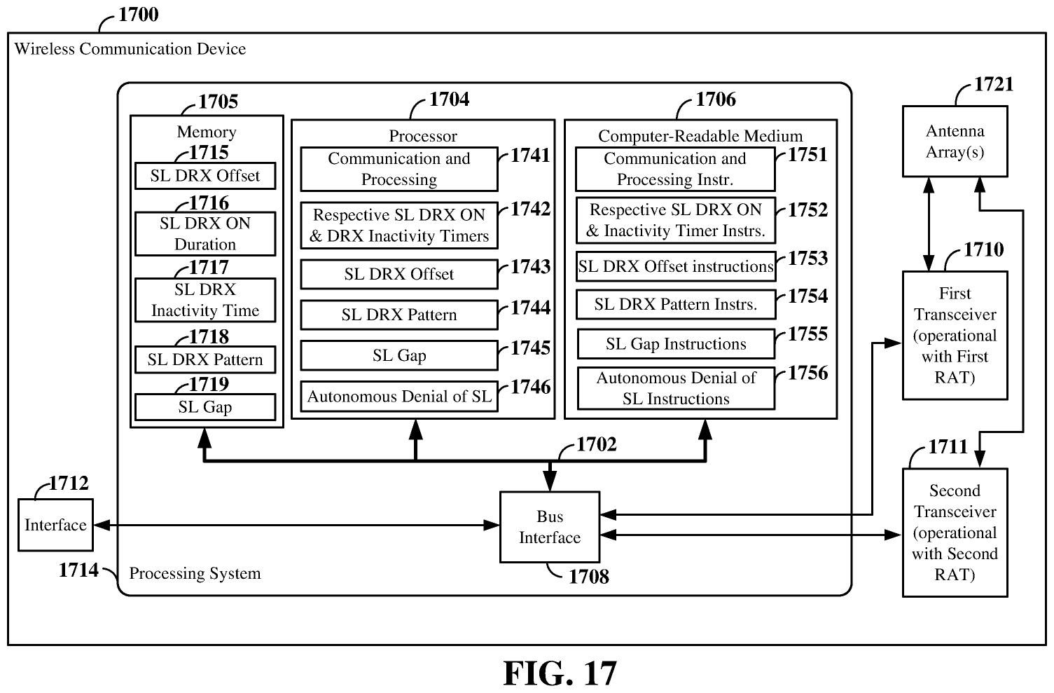

FIG. 17 is a block diagram illustrating an example of a hardware implementation of a wireless communication device 1700 (e.g., user equipment, a scheduled entity) (also referred to as a first wireless communication device 1700 herein) employing a processing system 1714 according to some aspects of the disclosure. The first wireless communication device 1700 may be similar to, for example, any of the wireless communication devices, UEs, receivers, transceivers, or scheduled entities of FIGS. 1, 2, 3, 5, 6, 8, 10, 12, 14A, 14B, 15, and/or 16.

In accordance with various aspects of the disclosure, an element, any portion of an element, or any combination of elements may be implemented with a processing system 1714 that includes one or more processors, such as processor 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the first wireless communication device 1700 may be configured to perform any one or more of the functions described herein. That is, the processor 1704, as utilized in the first wireless communication device 1700, may be used to implement any one or more of the methods or processes described and illustrated, for example, in FIGS. 10A, 10B, 12, 14A, 14B, 15, and/or 16.

In this example, the processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further.

A bus interface 1708 provides an interface between the bus 1702 and a first transceiver 1710. The first transceiver 1710 may be, for example, a wireless transceiver. The first transceiver 1710 may be operational with a first RAT (e.g., a first RAT that employs sidelink communication). The bus interface 1708 may also provide an interface between the bus 1702 and a second transceiver 1711. The second transceiver 1711 may be, for example, a wireless transceiver. The second transceiver 1711 may be operational with a second RAT (e.g., a second RAT that employs WiFi or Bluetooth communication). The first transceiver 1710 and the second transceiver 1711 may provide respective means for communicating with various other apparatus over a transmission medium (e.g., air interface). The first transceiver 1710 and the second transceiver 1711 may further be coupled to one or more antenna array(s) 1721. The bus interface 1708 further provides an interface between the bus 1702 and a user interface 1712 (e.g., keypad, display, touch screen, speaker, microphone, control features, etc.). Of course, such a user interface 1712 is optional, and may be omitted in some examples.

One or more processors, such as processor 1704, may be responsible for managing the bus 1702 and general processing, including the execution of software stored on the computer-readable medium 1706. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1706. The software, when executed by the processor 1704, causes the processing system 1714 to perform the various processes and functions described herein for any particular apparatus.

The computer-readable medium 1706 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product or article of manufacture. By way of example, a computer program product or article of manufacture may include a computer-readable medium in packaging materials. In some examples, the computer-readable medium 1706 may be part of the memory 1705. Those skilled in the art will recognize how best to implement the described functionality presented throughout this disclosure depending on the particular application and the overall design constraints imposed on the overall system. The computer-readable medium 1706 and/or the memory 1705 may also be used for storing data that is manipulated by the processor 1704 when executing software. For example, the memory 1705 may store an SL DRX offset in a SL DRX offset memory location 1715.

In some aspects of the disclosure, the processor 1704 may include communication and processing circuitry 1741 configured for various functions, including for example communicating with a network entity (e.g., a gNB, a base station, a scheduled entity), a network core (e.g., a 5G core network), another wireless communication device (e.g., a UE, a scheduled entity), and/or any other entity, such as, for example, local infrastructure or an entity communicating with the first wireless communication device 1700 via the Internet, such as a network provider. In some examples, the communication and processing circuitry 1741 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 1741 in conjunction with the first transceiver 1710 (operational with a first RAT) and/or a second transceiver 1711 (operational with a second RAT) and the antenna array(s) 1721 may be configured to initiate transmission of (or transmit) a first signal indicative of a first sidelink (SL) discontinuous reception (DRX) pattern associated with in-device coexistence (IDC) and selected to avoid IDC interference at the first wireless communication device 1700 between wireless communications utilizing a first radio access technology (RAT) and a second RAT in a given time-frequency resource, the first RAT being associated with sidelink communications and being different from the second RAT.

The communication and processing circuitry 1741 may further be configured to receive a second signal indicative of a second SL DRX pattern obtained in view of (e.g., following an evaluation of, after considering, based on) the first SL DRX pattern in response to the transmission of the first signal. For example, the first wireless communication device may be a SL Rx UE, a second wireless communication device may be a SL Tx UE, another device may be a network entity. The first wireless communication device (e.g., the SL Rx UE) may receive the second signal from the second wireless communication device (e.g., the Tx UE) or may receive the second signal from the network entity or may receive the second signal from the network entity via the second wireless communication device. The device from which the first wireless communication device receives the second signal (e.g., the second wireless communication device, the SL Tx UE, the network entity) may obtain the second SL DRX pattern in response to evaluating the first SL DRX pattern (e.g., a pattern preferred by the first wireless communication device) and concluding that no changes are needed to the first SL DRX pattern. In such a case, the first SL DRX pattern may be equal to the second SL DRX pattern. However, the device from which the first wireless communication device receives the second signal (e.g., the second wireless communication device, the SL Tx UE, the network entity) may obtain the second SL DRX pattern in response to evaluating the first SL DRX pattern and concluding that the first SL DRX pattern may cause issues that affect communication. These issues may include, but are not limited to, non-IDC issues that may be realized at the first wireless communication device, or any issues relating to interference with other devices. In such a case, the device transmitting the second signal may have evaluated the first SL DRX pattern (preferred by the first wireless communication device) and obtained the second SL DRX pattern in view of the first SL DRX pattern (e.g., obtained the second SL DRX pattern after considering consequences of utilizing the first SL DRX pattern); in this case, the obtained second SL DRX pattern may be different from the first SL DRX pattern. In such an example, although the first SL DRX patten may be selected by and desired or recommended by the first wireless communication device, the device transmitting the second signal (e.g., the second wireless communication device, the SL Tx UE, the network entity) may overrule the selection/desire/recommendation of the first wireless communication device and indicate the second SL DRX pattern (which may be different from the first SL DRX pattern).

The communication and processing circuitry 1741 may further be configured to configure the first wireless communication device 1700 according to the second SL DRX pattern. Accordingly, the first SL DRX pattern may be a preferred pattern selected by the first wireless communication device, and the second SL DRX pattern may be an indicated pattern received from a device from which the second signal was received. The indicated second SL DRX may be equal to or different from the first SL DRX pattern. The communication and processing circuitry 1741 may further be configured to execute communication and processing instructions 1751 (e.g., software) stored on the computer-readable medium 1706 to implement one or more functions described herein.

In some aspects of the disclosure, the processor 1704 may include respective SL DRX ON Timer circuitry and SL DRX inactivity timer circuitry 1742 (also referred to herein as an SL DRX ON timer and SL DRX inactivity timer, respectively) configured for various functions. The functions of the SL DRX ON timer circuitry (of the SL DRX ON Timer circuitry and SL DRX inactivity timer circuitry 1742) may include, for example, counting (e.g., up, or down) a RAT active time (e.g., a duration), such as the first RAT active time 1102, 1104, 1106, 1108, 1110 as shown and described in connection with FIG. 11, or the first RAT active time 1310 as shown and described in connection with FIG. 13, for example. The functions of the SL DRX inactivity timer circuitry (of the SL DRX ON Timer circuitry and SL DRX inactivity timer circuitry 1742) may include, for example, counting (e.g., up, or down) a SL DRX inactivity time (e.g., a duration) associated with an SL DRX inactivity period. As used herein, the SL DRX inactivity time (e.g., such as the SL DRX inactivity time 1312 as shown and described in connection with FIG. 13) may start during a RAT active time (e.g., such as the first RAT active time 1310 as shown and described in connection with FIG. 13) in response to receiving a communication via the RAT during the RAT active time. The SL DRX inactivity time may end after expiry of the RAT active time. The SL DRX ON duration may be stored, for example, in a SL DRX ON duration memory location 1716 in the memory 1705 of the first wireless communication device 1700. The SL DRX inactivity time may be stored, for example, in a SL DRX inactivity time memory location 1717 in the memory 1705 of the first wireless communication device 1700. Thus, according to some aspects, the SL DRX inactivity timer circuitry (of the SL DRX ON Timer circuitry and SL DRX inactivity timer circuitry 1742) may be configured to receive a duration of an SL DRX inactivity timer associated with a first SL DRX pattern, and set the SL DRX inactivity timer to the duration in response to receiving a sidelink communication during a first RAT active time. The respective SL DRX ON timer circuitry and SL DRX inactivity timer circuitry 1742 may further be configured to execute respective SL DRX ON timer circuitry and SL DRX inactivity timer instructions 1752 (e.g., software) stored on the computer-readable medium 1706 to implement one or more functions described herein.

In some aspects of the disclosure, the processor 1704 may include SL DRX offset circuitry 1743 configured for various functions, including, for example, determining, measuring, or identifying an SL DRX offset from a system reference time. The example of FIG. 13 depicts a system reference time 1306 and an SL DRX offset 1304, by way of example and not limitation. The SL DRX offset may be stored, for example, in a SL DRX offset memory location 1715 in the memory 1705 of the first wireless communication device 1700. The SL DRX offset circuitry 1743 may further be configured to execute SL DRX offset instructions 1753 (e.g., software) stored on the computer-readable medium 1706 to implement one or more functions described herein.

In some aspects of the disclosure, the processor 1704 may include first SL DRX pattern circuitry 1744 configured for various functions, including, for example, selecting, determining, or otherwise obtaining or identifying a first SL DRX pattern. The selected, determined, or otherwise obtained or identified first SL DRX pattern may be a first SL DRX pattern preferred or otherwise desired by the first wireless communication device 1700. The first SL DRX pattern may be selected (by the first wireless communication device) to avoid IDC interference at the first wireless communication device 1700 between wireless communications utilizing the first RAT (e.g., including the first transceiver 1710 that is operational with the first RAT) and the second RAT (e.g., including the second transceiver 1711 that is operational with the second RAT), where the first RAT is different from the second RAT, in a given time-frequency resource. According to some aspects, the first SL DRX pattern may be selected to avoid interference by separating, in the time domain, a sidelink related operation associated with the first RAT from at least one of: a non-sidelink related operation associated with the second RAT, or another operation associated with a third RAT, different from the first RAT and the second RAT. Examples of an SL DRX pattern are identified as a first RAT DRX pattern 1124 as shown and described in connection with FIG. 11, and a first RAT DRX pattern 1316, as shown and described in connection with FIG. 13. The SL DRX pattern may be stored, for example, in an SL DRX pattern memory location 1718 in the memory 1705 of the first wireless communication device 1700. The SL DRX pattern circuitry 1744 may further be configured to execute SL DRX pattern instructions 1754 (e.g., software) stored on the computer-readable medium 1706 to implement one or more functions described herein.

In some aspects of the disclosure, the processor 1704 may include SL gap circuitry 1745 configured for various functions, including, for example, selecting, determining, or otherwise obtaining or identifying, an SL gap during which SL communications may be inactive. The selected, determined, or otherwise obtained or identified SL gap may be a SL gap preferred or otherwise desired by the first wireless communication device 1700. According to some aspects, the functions of the SL gap circuitry 1745 may include, for example, transmitting (or initiating a transmission of) a first signal indicative of at least one of a first periodic sidelink (SL) gap or a first aperiodic SL gap (e.g., where the gap is a gap in time) associated with IDC and selected to avoid IDC interference at the first wireless communication device between wireless communications utilizing a first RAT and a second RAT in a given time-frequency resource, the first RAT being associated with sidelink communications and being different from the second RAT. The first RAT may include, for example, the first transceiver 1710 that is operational with a first RAT. The second RAT may include, for example, the second transceiver 1711 that is operational with a second RAT.

According to some aspects, the functions of the SL gap circuitry 1745 may include, for example, receiving a second signal indicative of at least one of a second periodic SL gap or a second aperiodic SL gap obtained in view of (e.g., following an evaluation of, after considering, based on) the at least one of the first periodic SL or the first aperiodic SL gap, respectively, in response to the transmission of the first signal. According to some aspects, the at least one of the first periodic SL gap or the first aperiodic SL gap is a preferred SL gap selected by the first wireless communication device, and the at least one of the second periodic SL gap or the second aperiodic SL gap is an indicated SL gap received from a device from which the second signal was received.

For example, the first wireless communication device may be a SL Rx UE, a second wireless communication device may be a SL Tx UE, another device may be a network entity. The first wireless communication device (e.g., the SL Rx UE) may receive the second signal from the second wireless communication device (e.g., the Tx UE) or may receive the second signal from the network entity or may receive the second signal from the network entity via the second wireless communication device. According to some aspects, the at least one of the first periodic SL gap or the first aperiodic SL gap may be a respective SL gap that may be preferred by the first wireless communication device. The device from which the first wireless communication device receives the second signal (e.g., the second wireless communication device, the SL Tx UE, the network entity) may obtain the at least one of the second periodic SL gap or the second aperiodic SL gap in response to evaluating the at least one of the first periodic SL gap or the first aperiodic SL gap, respectively, and concluding that no changes are needed to the respective one of the at least one of the second periodic SL gap or the second aperiodic SL gap. In such a case, the at least one of the first periodic SL gap or the first aperiodic SL gap is equal to the at least one of the second periodic SL gap or the second aperiodic SL gap, respectively. However, the device from which the first wireless communication device receives the second signal (e.g., the second wireless communication device, the SL Tx UE, the network entity) may obtain the at least one of the second periodic SL gap or the second aperiodic SL gap in response to evaluating the at least one of the first periodic SL gap or the first aperiodic SL gap, respectively, and concluding that the at least one of the first periodic SL gap or the first aperiodic SL gap may cause issues that affect communication. These issues may include, but are not limited to, non-IDC issues that may be realized at the first wireless communication device, or any issues relating to interference with other devices. In such a case, the device transmitting the second signal may have evaluated the at least one of the first periodic SL gap or the first aperiodic SL gap (e.g., an SL gap preferred by the first wireless communication device) and obtained the at least one of the second periodic SL gap or the second aperiodic SL gap, respectively, in view of the at least one of the first periodic SL gap or the first aperiodic SL gap (e.g., obtained the at least one of the second periodic SL gap or the second aperiodic SL gap after considering consequences of utilizing the at least one of the first periodic SL gap or the first aperiodic SL gap, respectively); in this case, the obtained at least one of the second periodic SL gap or the second aperiodic SL gap may be different from the at least one of the first periodic SL gap or the first aperiodic SL gap, respectively. In such an example, although the at least one of the first periodic SL gap or the first aperiodic SL gap may be selected by and desired or recommended by the first wireless communication device, the device transmitting the second signal (e.g., the second wireless communication device, the SL Tx UE, the network entity) may overrule the selection/desire/recommendation of the first wireless communication device and indicate the at least one of the second periodic SL gap or the second aperiodic SL gap (which may be different from the at least one of the first periodic SL or the first aperiodic SL gap, respectively).

According to some aspects, the functions of the SL gap circuitry 1745 may include, for example, configuring the first wireless communication device according to the at least one of the second periodic SL gap or the second aperiodic SL gap.

Examples of a SL gap may be identified as a long term gaps 1114, 1116, 1118, 1120, 1122 as shown and described in connection with FIG. 11, and a second RAT active time 1314 as shown and described in connection with FIG. 13. The SL gap may be stored, for example, in a SL gap memory location 1719 in the memory 1705 of the first wireless communication device 1700. According to some aspects, the first wireless communication device may transmit the first signal to a second wireless communication device when operating with the second wireless communication device in sidelink Mode 2. According to some aspects, the at least one of the first periodic SL gap or the first aperiodic SL gap may be transmitted from the first wireless communication device to a second wireless communication device. According to some aspects, the at least one of the second periodic SL gap or the second aperiodic SL gap may be received at the first wireless communication device from the second wireless communication device in a radio resource control configuration message. In some examples, the first wireless communication device may be configured to transmit a value of the at least one of the first periodic SL gap or the first aperiodic SL gap (e.g., an in-device coexistence time gap) as sidelink user equipment assistance information (SL UAI) via inter-user equipment (inter-UE) coordination (IUC) signaling with a second wireless communication device. In some examples, the first wireless communication device may transmit a value of the at least one of the first periodic SL gap or the first aperiodic SL gap as a groupcast. In some examples, the at least one of the first periodic SL gap or the first aperiodic SL gap may be provided on at least one of a per-resource pool, a per-sidelink bandwidth part, or a per-band basis.

According to some aspects, the first wireless communication device may be a sidelink receiving device (e.g., a SL Rx UE 1604 as shown and described in connection with FIG. 16) and may operate in sidelink Mode 1. The first wireless device may be configured to transmit (or a processor of the first wireless device may be configured to initiate transmission of) an indication (e.g., to report) of a value of the at least one of the first periodic SL gap or the first aperiodic SL gap to a network entity (e.g., the network entity 1606 as shown and described in connection with FIG. 16) via a sidelink transmitting device (e.g., SL Tx UE 1602 as shown and described in connection with FIG. 16). In some examples, the indication of the value of the at least one of the first periodic SL gap or the first aperiodic SL gap may be configured by the network entity via radio resource control signaling.

The SL gap circuitry 1745 may further be configured to execute SL gap instructions 1755 (e.g., software) stored on the computer-readable medium 1706 to implement one or more functions described herein.

In some aspects of the disclosure, the processor 1704 may include autonomous denial of SL circuitry 1746 configured for various functions, including, for example, receiving a configuration that configures the first wireless communication device 1700 to autonomously deny a sidelink transmission in response to the sidelink transmission prospectively causing in-device coexistence (IDC) interference at the first wireless communication device between wireless communications utilizing a first radio access technology (RAT) and a second RAT in a given time-frequency resource, the first RAT being associated with sidelink communications and being different from the second RAT. According to some aspects, the first wireless communication device 1700 may be a SL Tx UE, such as the Tx UE 1602 as shown and described in connection with FIG. 16, for example. According to some aspects, the first wireless communication device 1700 may be any of the UEs as shown and described in any of FIGS. 1, 2, 3, 5, 6, 8, 10A, 10B, 12, 14A, 14B, 15, and/or 16, for example. The autonomous denial of SL may be configured to the first wireless communication device 1700 by a network entity (e.g., a gNB), for example. The network entity may be exemplified by the network entity 1606 as shown and described in connection with FIG. 16, or any of the network entities as shown and described in any of FIGS. 1, 2, 3, 5, 6, 8, 10A, 10B, 12, 14A, 14B, and/or 15.

The autonomous denial of SL circuitry 1746 may be configured for other functions including, for example, receiving a validity period and a maximum number of resources the wireless communication device is enabled to autonomously deny. The validity period and a maximum number of resources may be stored, for example, in the memory 1705 of the first wireless communication device 1700. The autonomous denial of SL circuitry 1746 may be configured for other functions including, for example, periodically transmitting, or periodically initiating a transmission of an indication of (e.g., reporting) a quantity of autonomous denial events that may take place over a given period via at least one of: a medium access control—control element (MAC-CE), or radio resource control (RRC) signaling. In connection with the autonomous denial features exemplified herein, the wireless communication device may operate in sidelink Mode 1. The autonomous denial of SL circuitry 1746 may further be configured to execute autonomous denial of SL instructions 1756 (e.g., software) stored on the computer-readable medium 1706 to implement one or more functions described herein.

In general, a wireless communication device, such as first wireless communication device 1700 may generally include a memory 1705, a first transceiver 1710 (e.g., a first transmitter/receiver, a first radio) configured to operate utilizing a first radio access technology (RAT) associated with sidelink communications, and a second transceiver 1711 (e.g., a second transmitter/receiver, a second radio) configured to operate utilizing a second RAT, the first transceiver and the first RAT being different from the second transceiver and the second RAT, and a processor 1704 coupled to the first transceiver 1710, the second transceiver 1711, and the memory 1705.

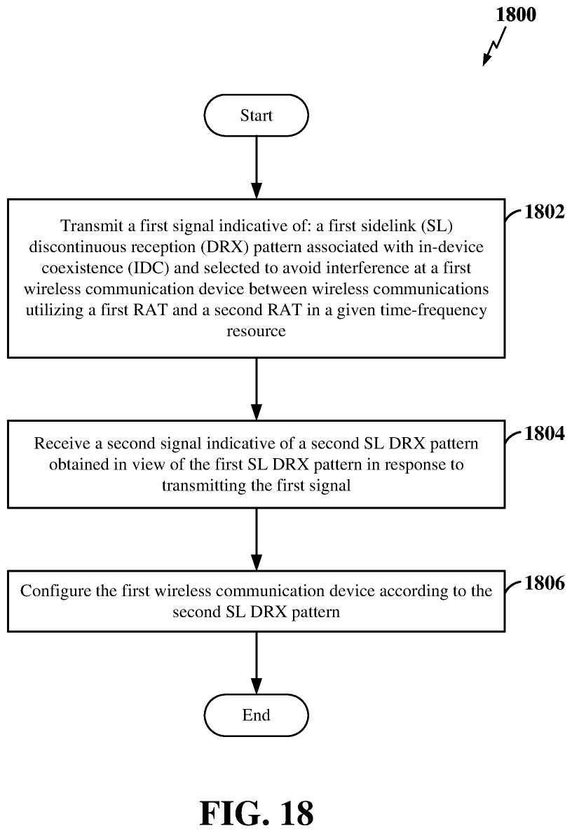

FIG. 18 is a flow chart illustrating an example process 1800 (e.g., a method) of wireless communication, in a wireless communication network, at a first wireless communication device according to some aspects of the disclosure. As described below, some or all illustrated features may be omitted in a particular implementation within the scope of the present disclosure, and some illustrated features may not be required for implementation of all examples. In some examples, the process 1800 may be carried out by the first wireless communication device 1700 as illustrated and described in connection with FIG. 17. The first wireless communication device 1700 may be similar to, for example, any of the wireless communication devices, UEs, or scheduled entities of FIGS. 1, 2, 3, 5, 6, 8, 10A, 10B, 12, 14A, 14B, 15 and/or 16. In some examples, the process 1800 may be carried out by any suitable apparatus or means for carrying out the functions or algorithm described below.

At block 1802, the wireless communication device may transmit (or a processor of the wireless communication device may initiate transmission of) a first signal indicative of a first sidelink (SL) discontinuous reception (DRX) pattern associated with in-device coexistence (IDC) and selected to avoid IDC interference at the first wireless communication device between wireless communications utilizing a first RAT and a second RAT in a given time-frequency resource, the first RAT being associated with sidelink communications and being different from the second RAT. For example, the communication and processing circuitry 1741 and/or the SL DRX pattern circuitry 1744 in conjunction with either the first transceiver 1710 or the second transceiver 1711 and the antenna array(s) 1721 as shown and described above in connection with FIG. 17 may provide a means to transmit (or a processor of the wireless communication device may provide a means to initiate transmission of) a first signal indicative of a first sidelink (SL) discontinuous reception (DRX) pattern associated with in-device coexistence (IDC) and selected to avoid IDC interference at the first wireless communication device between wireless communications utilizing the first RAT and the second RAT in a given time-frequency resource, the first RAT being associated with sidelink communications and being different from the second RAT.

At block 1804, the wireless communication device may receive a second signal indicative of a second SL DRX pattern obtained in view of (e.g., following an evaluation of, after considering, based on) the first SL DRX pattern in response to transmitting the first signal. As described above in connection with FIG. 17, the first SL DRX pattern may be a preferred pattern selected by the first wireless communication device, and the second SL DRX pattern may be an indicated pattern received from a device from which the second signal was received. For example, the communication and processing circuitry 1741 and/or the SL DRX pattern circuitry 1744 in conjunction with either the first transceiver 1710 or the second transceiver 1711 and the antenna array(s) 1721 as shown and described above in connection with FIG. 17 may provide a means to receive a second signal indicative of a second SL DRX pattern obtained in view of the first SL DRX pattern in response to transmitting the first signal.

At block 1806, the wireless communication device may configure the first wireless communication device according to the second SL DRX pattern. For example, the communication and processing circuitry 1741 and/or the SL DRX pattern circuitry 1744 as shown and described above in connection with FIG. 17 may provide a means to configure the first wireless communication device according to the second SL DRX pattern.

According to some aspects, the second SL DRX pattern may utilize time division multiplexing to at least one of: receive utilizing the first RAT on a sidelink communication interface (e.g., a PC-5 interface) in sidelink licensed spectrum and transmit utilizing the second RAT on a second communication interface, or receive utilizing the first RAT on the sidelink communication interface in sidelink unlicensed spectrum and at least one of receive or transmit utilizing the second RAT on the second communication interface. For example, the communication and processing circuitry 1741, in connection with the first transceiver 1710, the second transceiver 1711 and the antenna arrays 1721, as shown and described in connection with FIG. 17, may provide a means to receive utilizing the first RAT on a sidelink communication interface (e.g., a PC-5 interface) in sidelink licensed spectrum and transmit utilizing the second RAT on a second communication interface, or the means to receive utilizing the first RAT on the sidelink communication interface in sidelink unlicensed spectrum and at least one of receive or transmit utilizing the second RAT on the second communication interface.

According to some aspects, the SL DRX pattern circuitry 1744 may further provide a means to transmit, or to initiate transmission of, a sidelink DRX information element including at least a field representative of the first SL DRX pattern. In some examples, the SL DRX pattern may be signaled on a per subchannel basis. According to other aspects, the SL DRX pattern circuitry 1744 may further provide a means to transmit, or to initiate transmission of, an indication of (e.g., a report of) a network interface that is a source of potential in-device coexistence interference. According to other aspects, the SL DRX pattern circuitry 1744 may still further provide a means to transmit, or to initiate transmission of, a sidelink DRX information element comprising a field representative of a network interface that is a source of potential in-device coexistence interference. According to other aspects, the SL DRX pattern circuitry 1744 may still further provide a means to receive radio resource control (RRC) signaling including the second SL DRX pattern from a second wireless communication device or a network entity on a per-resource pool, per-bandwidth part, or per-subchannel basis. As described above, the SL DRX pattern may be selected to avoid interference by, for example, separating, in the time domain, a sidelink related operation associated with a first RAT, from at least one of: a non-sidelink related operation associated with a second RAT (different from the first RAT), or another operation associated with a third RAT, different from the first RAT and the second RAT.

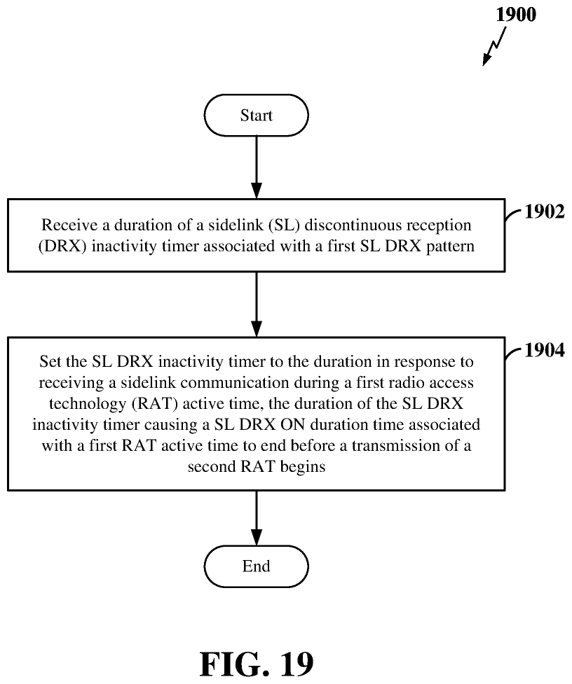

FIG. 19 is a flow chart illustrating an example process 1900 (e.g., a method) of wireless communication, in a wireless communication network, at a first wireless communication device according to some aspects of the disclosure. As described below, some or all illustrated features may be omitted in a particular implementation within the scope of the present disclosure, and some illustrated features may not be required for implementation of all examples. In some examples, the process 1900 may be carried out by the first wireless communication device 1700 as illustrated and described in connection with FIG. 17. The first wireless communication device 1700 may be similar to, for example, any of the wireless communication devices, UEs, or scheduled entities of FIGS. 1, 2, 3, 5, 6, 8, 10A, 10B, 12, 14A, 14B, 15 and/or 16. In some examples, the process 1800 may be carried out by any suitable apparatus or means for carrying out the functions or algorithm described below.

At block 1902, the first wireless communication device may receive a duration of an SL DRX inactivity timer associated with a first SL DRX pattern. According to some aspects, the received duration of the SL DRX inactivity timer may have been previously selected by the first wireless communication device and may represent a duration that is preferred by the first wireless communication device. According to some aspects, the received duration may be received from, for example, a SL Tx UE or a network entity (e.g., received directly from the network entity or received from the network entity via the SL Tx UE). In response to earlier receiving the duration, the SL Tx UE, or the network entity (e.g., the device from which the duration was received at block 1902) may have evaluated the earlier received duration and either did not change the earlier received duration or changed the earlier received duration to the duration received at block 1902. According to some aspects, the device from which the duration was received may have indicated the duration without an evaluation of a preferred duration previously transmitted to the device from the first wireless communication device. According to some aspects, the duration received at block 1902 may be at least one of: equal to a duration previously selected by the first wireless communication device, or not equal to the duration previously selected by the first wireless communication device. According to some aspects, the duration may be obtained from a device (e.g., the SL Tx UE or the network entity) that selected the duration without consideration of an earlier duration selected by (e.g., preferred by) the first wireless communication device.

According to some aspects, the first SL DRX pattern may be associated with in-device coexistence (IDC) and may be selected to avoid IDC interference at the first wireless communication device between wireless communications utilizing a first RAT and a second RAT in a given time-frequency resource. According to some aspects, the first SL DRX pattern may be selected to avoid interference by separating, in the time domain, a sidelink related operation associated with the first RAT from at least one of: a non-sidelink related operation associated with the second RAT, or another operation associated with a third RAT, different from the first RAT and the second RAT.

For example, the SL DRX inactivity timer circuitry (of the SL DRX ON Timer circuitry and SL DRX inactivity timer circuitry 1742) in conjunction with either the first transceiver 1710 or the second transceiver 1711 and the antenna array(s) 1721 as shown and described above in connection with FIG. 17 may provide a means to receive a duration of an SL DRX inactivity timer associated with a first SL DRX pattern.

At block 1904, the wireless communication device may set the SL DRX inactivity timer to the duration (e.g., received at block 1902) in response to receiving a sidelink communication during a first RAT active time, the duration of the SL DRX inactivity timer causing a SL DRX ON duration time associated with a first RAT active time to end before a transmission of a second RAT begins. For example, the SL DRX inactivity timer circuitry (of the SL DRX ON Timer circuitry and SL DRX inactivity timer circuitry 1742) may provide a means to set the SL DRX inactivity timer to the duration in response to receiving a sidelink communication during a first RAT active time, the duration of the SL DRX inactivity timer causing a SL DRX ON duration time associated with a first RAT active time to end before a transmission of a second RAT begin.

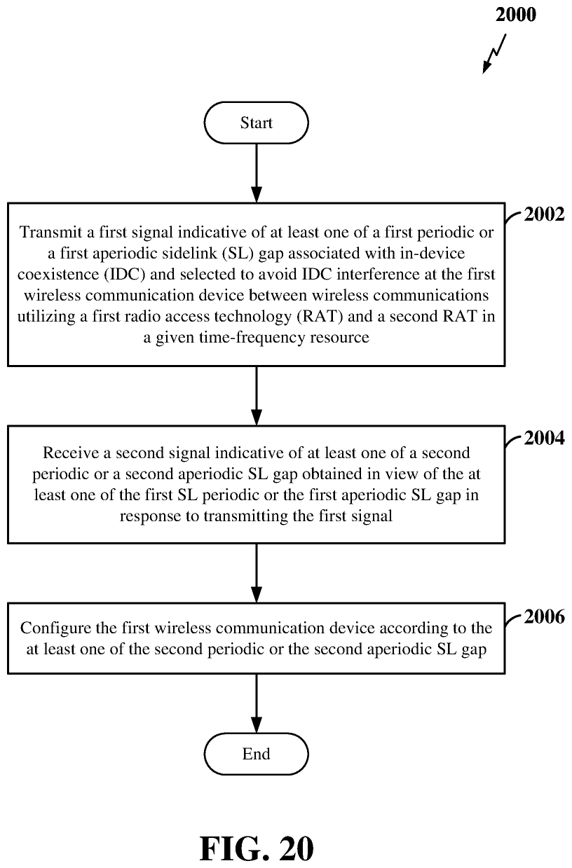

FIG. 20 is a flow chart illustrating an example process 2000 (e.g., a method) of wireless communication, in a wireless communication network, at a first wireless communication device according to some aspects of the disclosure. As described below, some or all illustrated features may be omitted in a particular implementation within the scope of the present disclosure, and some illustrated features may not be required for implementation of all examples. In some examples, the process 2000 may be carried out by the first wireless communication device 1700 as illustrated and described in connection with FIG. 17. The first wireless communication device 1700 may be similar to, for example, any of the wireless communication devices, UEs, or scheduled entities of FIGS. 1, 2, 3, 5, 6, 8, 10A, 10B, 12, 14A, 14B, 15, and/or 16. In some examples, the process 2000 may be carried out by any suitable apparatus or means for carrying out the functions or algorithm described below.

At block 2002, the wireless communication device may transmit (or a processor of the wireless communication device may initiate transmission of) a first signal indicative of at least one of a first periodic SL gap or a first aperiodic SL gap (e.g., a gap in time) associated with in-device coexistence (IDC) and selected to avoid IDC interference at the first wireless communication device between wireless communications utilizing a first RAT and a second RAT in a given time-frequency resource, the first RAT being associated with sidelink communications and being different from the second RAT. For example, the SL gap circuitry 1745 in conjunction with either the first transceiver 1710 or the second transceiver 1711 and the antenna arrays 1721 as shown and described above in connection with FIG. 17 may provide a means to transmit (or a means to initiate transmission of) a first signal indicative of at least one of a first periodic SL or a first aperiodic SL gap associated with IDC and selected to avoid IDC interference at the first wireless communication device between wireless communications utilizing a first RAT and a second RAT in a given time-frequency resource, the first RAT being associated with sidelink communications and being different from the second RAT.

At block 2004, the wireless communication device may receive a second signal indicative of at least one of a second periodic SL gap or a second aperiodic SL gap obtained in view of (e.g., following an evaluation of, after considering, based on) the at least one of the first periodic SL gap or the first aperiodic SL gap in response to transmitting (or in response to the transmission of) the first signal. For example, the communication and processing circuitry 1741 and/or the SL gap circuitry 1745 in conjunction with either the first transceiver 1710 or the second transceiver 1711 and the antenna arrays 1721 as shown and described above in connection with FIG. 17 may provide a means to receive a second signal indicative of at least one of a second periodic SL gap or a second aperiodic SL gap obtained in view of the at least one of the first periodic SL or the first aperiodic SL gap in response to transmitting (or in response to the transmission of) the first signal.

At block 2006, the first wireless communication dive may configure the first wireless communication device according to the at least one of the second periodic SL gap or the second aperiodic SL gap. For example, the SL gap circuitry 1745 as shown and described above in connection with FIG. 17 may provide a means to configure the first wireless communication device according to the at least one of the second periodic SL gap or the second aperiodic SL gap.

According to some aspects, the first wireless communication device may transmit (or initiate the transmission of) the first signal to a second wireless communication device when operating with the second wireless communication device in sidelink Mode 2. According to some aspects, the at least one of the first periodic SL gap or the first aperiodic SL gap may be transmitted from the first wireless communication device to a second wireless communication device. According to some aspects, the at least one of the second periodic SL gap or the second aperiodic SL gap may be received at the first wireless communication device from the second wireless communication device in a radio resource control configuration message.

In some examples, the first wireless communication device may be configured to transmit (or a processor of the first wireless communication device may be configured to initiate transmission of) a value of the at least one of the first periodic SL gap or the first aperiodic SL gap (e.g., an in-device coexistence time gap) as sidelink user equipment assistance information (SL UAI) via inter-user equipment (inter-UE) coordination (IUC) signaling with a second wireless communication device. In some examples, the first wireless communication device may transmit a value of the at least one of the first periodic SL or the first aperiodic SL gap as a groupcast. In some examples, the at least one of the first periodic SL gap or the first aperiodic SL gap may be provided on at least one of a per-resource pool, a per-sidelink bandwidth part, or a per-band basis.

According to some aspects, the first wireless communication device may be a sidelink receiving device (e.g., a SL Rx UE 1604 as shown and described in connection with FIG. 16) and operates in sidelink Mode 1, the first wireless device be configured to initiate transmission of an indication of (e.g., report) a value of the at least one of the first periodic SL gap or the first aperiodic SL gap to a network entity (e.g., the network entity 1606 as shown and described in connection with FIG. 16) via a sidelink transmitting device (e.g., SL Tx UE 1602 as shown and described in connection with FIG. 16). In some examples, the indication (e.g., the report) of the value of the at least one of the first periodic SL gap or the first aperiodic SL gap may be configured by the network entity via radio resource control signaling.

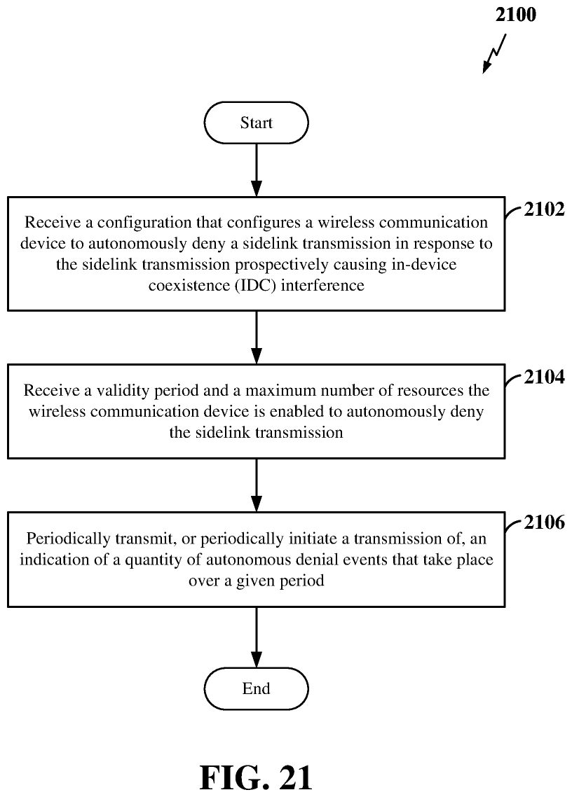

FIG. 21 is a flow chart illustrating an example process 2100 (e.g., a method) of wireless communication, in a wireless communication network, at a wireless communication device according to some aspects of the disclosure. As described below, some or all illustrated features may be omitted in a particular implementation within the scope of the present disclosure, and some illustrated features may not be required for the implementation of all examples. In some examples, the process 2100 may be carried out by the first wireless communication device 1700 as illustrated and described in connection with FIG. 17. The first wireless communication device 1700 may be similar to, for example, any of the wireless communication devices, UEs, or scheduled entities of FIGS. 1, 2, 3, 5, 6, 8, 10A, 10B, 12, 14A, 14B, 15, and/or 16. In some examples, the process 2100 may be carried out by any suitable apparatus or means for carrying out the functions or algorithm described below.

At block 2102, the wireless communication device may receive a configuration that configures the wireless communication device to autonomously deny a sidelink transmission in response to the sidelink transmission prospectively causing in-device coexistence (IDC) interference at the wireless communication device between wireless communications utilizing a first radio access technology (RAT) and a second RAT in a given time-frequency resource, the first RAT being associated with sidelink communications and being different from the second RAT. For example, the autonomous denial of SL circuitry 1746 in conjunction with either the first transceiver 1710 or the second transceiver 1711 and the antenna array(s) 1721 as shown and described above in connection with FIG. 17 may provide a means to receive a configuration that configures the wireless communication device to autonomously deny a sidelink transmission in response to the sidelink transmission prospectively causing in-device coexistence (IDC) interference at the wireless communication device between wireless communications utilizing a first radio access technology (RAT) and a second RAT in a given time-frequency resource, the first RAT being associated with sidelink communications and being different from the second RAT. According to some aspects, the configuration may be indicated by a network entity such as, for example, the network entity 1606 as shown and described in connection with FIG. 16. According to some aspects, the wireless communication device may operate in sidelink Mode 1 (e.g., with the network entity).

At block 2104, the wireless communication device may receive a validity period and a maximum number of resources the wireless communication device is enabled to autonomously deny (e.g., autonomously deny sidelink transmissions in response to the sidelink transmissions prospectively causing the IDC interference). In some examples, the validity period and the maximum number of resources may be configured to the wireless communication device from a network entity. For example, the autonomous denial of SL circuitry 1746 in conjunction with either the first transceiver 1710 or the second transceiver 1711 and the antenna array(s) 1721 as shown and described above in connection with FIG. 17 may provide a means to receive a validity period and a maximum number of resources the wireless communication device is enabled to autonomously deny (e.g., autonomously deny sidelink transmissions in response to the sidelink transmissions prospectively causing the IDC interference).

At block 2106, the wireless communication device may periodically transmit, or periodically initiate transmission of (e.g., periodically report) an indication of a quantity of autonomous denial events that take place over a given period. The periodic transmission may be via at least one of: a medium access control—control element (MAC-CE), or radio resource control (RRC) signaling. In some examples, a network entity may configure the wireless communication device to periodically transmit, or periodically initiate transmission of, a quantity of autonomous denial events that take place over a given period via at least one of: a medium access control—control element (MAC-CE), or radio resource control (RRC) signaling. For example, the autonomous denial of SL circuitry 1746 in conjunction with either the first transceiver 1710 or the second transceiver 1711 and the antenna array(s) 1721 as shown and described above in connection with FIG. 17 may provide a means to periodically transmit, or a means to periodically initiate transmission of (e.g., periodically report), a quantity of autonomous denial events that take place over a given period (e.g., via at least one of: a medium access control—control element (MAC-CE), or radio resource control (RRC) signaling). Although FIG. 21 includes blocks 2102, 2004, and 2106, block 2102 may be performed independently of blocks 2104 and 2106.

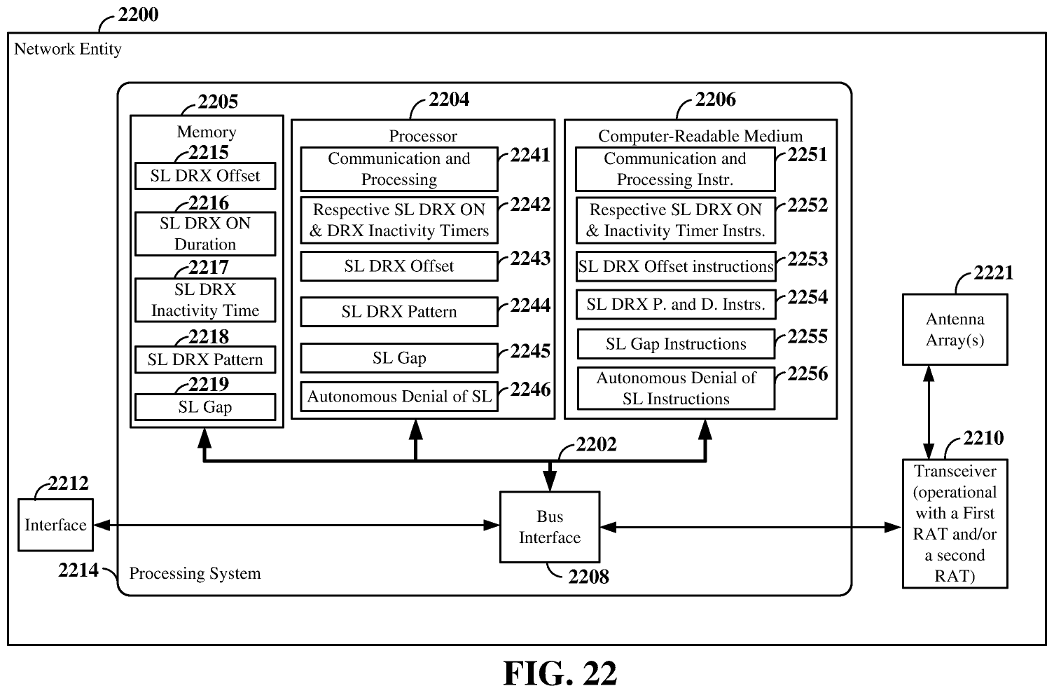

FIG. 22 is a block diagram illustrating an example of a hardware implementation of a network entity 2200 (e.g., a gNB, a base station, a scheduling entity) employing a processing system 2214 according to some aspects of the disclosure. The network entity 2200 may be similar to, for example, any of the network entities or scheduling entities of FIGS. 1, 2, 3, 5, 6, 8, 10A, 10B, 12, 14A, 14B, 15, and/or 16.

The processing system 2214 may be substantially the same as the processing system 1714 illustrated in FIG. 17, including a bus interface 2208, a bus 2202, a memory 2205, a processor 2204, and a computer-readable medium 2206. In accordance with various aspects of the disclosure, an element, or any portion of an element, or any combination of elements may be implemented with a processing system 2214 that includes one or more processors, such as processor 2204. Furthermore, the network entity 2200 may include a user interface 2212, a transceiver 2210 (operational with a first RAT and/or a second RAT), and one or more antenna array(s) 2221 substantially similar to those described above in connection with FIG. 17. The transceiver 2210 may be, for example, a wireless transceiver. The processor 2204, as utilized in a network entity 2200, may be used to implement any one or more of the processes described herein and illustrated, for example, in FIGS. 10A, 10B, 12, 13, 14A, 14B, 15, and/or 16.

In some aspects of the disclosure, the processor 2204 may include communication and processing circuitry 2241 configured for various functions, including for example communicating with a wireless communication device (e.g., a UE), a network core (e.g., a 5G core network), and another network entity (e.g., a gNB, a base station, a scheduling entity), or any other entity, such as, for example, local infrastructure or an entity communicating with the network entity 2200 via the Internet, such as a network provider. In some examples, the communication and processing circuitry 2241 may include one or more hardware components that provide the physical structure that performs processes related to wireless communication (e.g., signal reception and/or signal transmission) and signal processing (e.g., processing a received signal and/or processing a signal for transmission). The communication and processing circuitry 2241 may further be configured to execute communication and processing instructions 2251 (e.g., software) stored on the computer-readable medium 2206 to implement one or more functions described herein.

In some aspects of the disclosure, the processor 2204 may include respective SL DRX ON timer circuitry and SL DRX inactivity timer circuitry 2242 (also referred to herein as an SL DRX ON Timer and SL DRX inactivity timer, respectively) configured for various functions. The functions of the SL DRX ON timer circuitry (of the SL DRX ON timer circuitry and SL DRX inactivity timer circuitry 2242) may include, for example, obtaining from a wireless communication device, or otherwise determining or identifying, a RAT active time, such as the first RAT active time 1102, 1104, 1106, 1108, 1110 as shown and described in connection with FIG. 11, or the first RAT active time 1310 as shown and described in connection with FIG. 13, for example. The functions of the SL DRX inactivity timer circuitry (of the SL DRX ON timer circuitry and SL DRX inactivity timer circuitry 2242) may include, for example, obtaining from a wireless communication device, or otherwise determining or identifying a SL DRX inactivity time (e.g., a duration) associated with an SL DRX inactivity period. The SL DRX ON time and timer and the SL DRX inactivity time and timer have been described above and the descriptions will not be repeated for the sake of brevity. The SL DRX ON duration may be stored, for example, in a SL DRX ON duration memory location 2216 in the memory 2205 of the network entity 2200. The SL DRX inactivity time may be stored, for example, in a SL DRX inactivity time memory location 2217 in the memory 2205 of the network entity 2200. The respective SL DRX ON timer circuitry and SL DRX inactivity timer circuitry 2242 may further be configured to execute respective SL DRX ON timer circuitry and SL DRX inactivity timer instructions 2252 (e.g., software) stored on the computer-readable medium 2206 to implement one or more functions described herein.

In some aspects of the disclosure, the processor 2204 may include SL DRX offset circuitry 2243 configured for various functions, including, for example, obtaining from a wireless communication device, or otherwise determining or identifying, an SL DRX offset from a system reference time. The SL DRX offset has been described above, accordingly the description will not be repeated for the sake of brevity. The SL DRX offset may be stored, for example, in a SL DRX offset memory location 2215 in the memory 2205 of the network entity 2200. The SL DRX offset circuitry 2243 may further be configured to execute SL DRX offset instructions 2253 (e.g., software) stored on the computer-readable medium 2206 to implement one or more functions described herein.

In some aspects of the disclosure, the processor 2204 may include SL DRX pattern circuitry 2244 configured for various functions, including, for example, obtaining from a wireless communication device, or otherwise determining or identifying an SL DRX pattern. The SL DRX pattern has been described above; accordingly, the description will not be repeated for the sake of brevity. The SL DRX pattern may be stored in an SL DRX pattern memory location 2218 in the memory 2205 of the network entity 2200. The SL DRX pattern circuitry 2244 may further be configured to execute SL DRX pattern instructions 2254 (e.g., software) stored on the computer-readable medium 2206 to implement one or more functions described herein.

In some aspects of the disclosure, the processor 2204 may include SL gap circuitry 2245 configured for various functions, including, for example, obtaining from a wireless communication device, or otherwise determining or identifying, an SL gap (including a periodic SL gap and/or an aperiodic SL gap). As used herein, the word gap contemplates both the singular and the plural. The SL gap has been described above, accordingly the description will not be repeated for the sake of brevity. The SL gap may be stored, for example, in a SL gap memory location 2219 in the memory 2205 of the network entity 2200. The SL gap circuitry 2245 may further be configured to execute SL gap instructions 2255 (e.g., software) stored on the computer-readable medium 2206 to implement one or more functions described herein.

In some aspects of the disclosure, the processor 2204 may include autonomous denial of SL circuitry 2246 configured for various functions, including, for example, obtaining from a wireless communication device, or otherwise determining or identifying, a configuration that configures the wireless communication device to autonomously deny a sidelink transmission in response to the sidelink transmission prospectively causing in-device coexistence (IDC) interference. According to some aspects, the wireless communication device may be a Tx UE, such as any of the UEs as shown and described in any of FIGS. 1, 2, 3, 5, 6, 8, 10A, 10B, 12, 14A, 14B, 15 and/or 16. The autonomous denial of SL may be configured to the wireless communication device by the network entity 2200, for example. The network entity 2200, for example by use of the autonomous denial of SL circuitry 2246, may further configure the wireless communication device (e.g., a Tx UE) with a validity period and a maximum number of resources the wireless communication device is enabled to autonomously deny sidelink transmissions that may prospectively cause the IDC interference. To configure the wireless communication device as described, the autonomous denial of SL circuitry 2246 may be configured to transmit, or initiate the transmission of, the configuration to the wireless communication device. The validity period and a maximum number of resources may be stored, for example, in the memory 2205 of the network entity 2200. The autonomous denial of SL circuitry 2246 may further be configured to configure the wireless communication device to periodically transmit, or periodically initiate the transmission of an indication of (e.g., a report of) a quantity of autonomous denial events that take place over a given period via at least one of: a medium access control—control element (MAC-CE), or radio resource control (RRC) signaling. The autonomous denial of SL circuitry 2246 may further be configured to execute autonomous denial of SL instructions 2256 (e.g., software) stored on the computer-readable medium 2206 to implement one or more functions described herein.

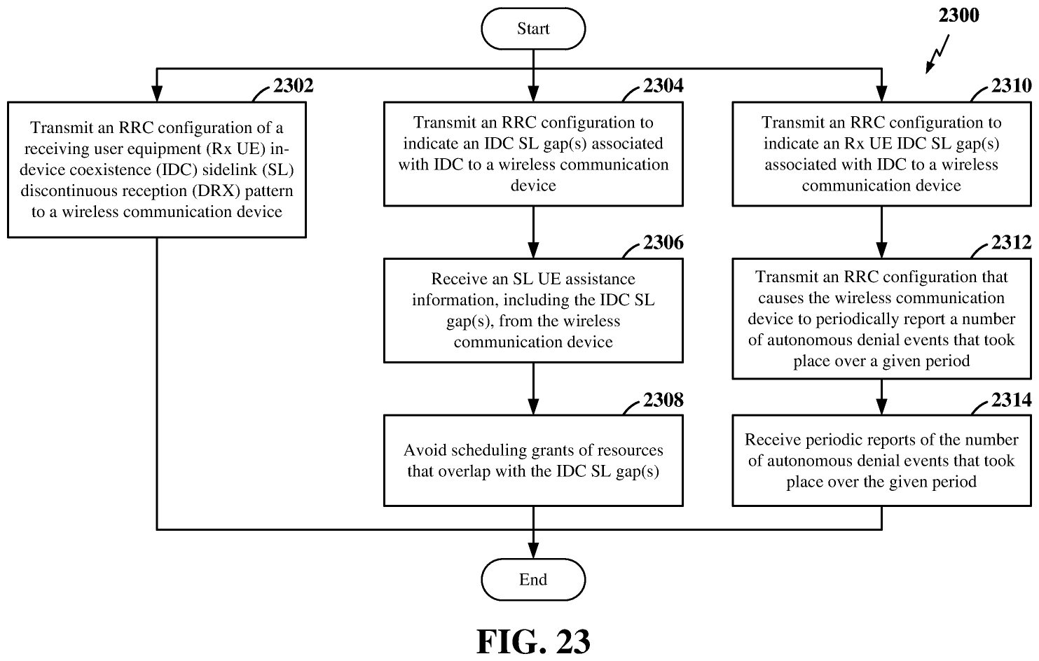

FIG. 23 is a flow chart illustrating an example process 2300 (e.g., a method) of wireless communication, in a wireless communication network, at a network entity according to some aspects of the disclosure. As described below, some or all illustrated features may be omitted in a particular implementation within the scope of the present disclosure, and some illustrated features may not be required for the implementation of all examples. In some examples, the process 2300 may be carried out by the network entity 2200 as illustrated and described in connection with FIG. 22. The network entity 2200 may be similar to, for example, any of the network entities, gNBs, or scheduling entities of FIGS. 1, 2, 3, 5, 6, 9, and/or 13. In some examples, the process 2300 may be carried out by any suitable apparatus or means for carrying out the functions or algorithm described below.

At block 2302, the network entity may transmit an RRC configuration of an SL DRX pattern associated with IDC (e.g., selected by, recommended by the network entity) to a wireless communication device (e.g., to an Rx UE, such as the Rx UE 1402 (e.g., either directly or via a Tx UE, such as the Tx UE 1404) as shown and described in connection with FIGS. 14A and 14B). In the example of FIG. 14A, the SL DRX pattern associated with IDC may be identified as either the first IDC Rx UE SL DRX pattern in connection with the SL RRC configuration 1408 or the third IDC Rx UE SL DRX pattern in connection with the SL RRC configuration 1412a, for example. In the example of FIG. 14B, the SL DRX pattern associated with IDC may be identified as the second IDC Rx UE SL DRX pattern in connection with the RRC configuration 1426, for example. Thereafter, the process 2300 may end. For example, the SL DRX pattern circuitry 2244 in conjunction with the transceiver 2210 and the antenna array(s) 2221 as shown and described above in connection with FIG. 22 may provide a means to transmit an RRC configuration of an SL DRX pattern associated with IDC to a wireless communication device. Descriptions of the SL DRX patterns associated with IDC (including those described in connection with FIGS. 14A and 14B) have been described above, accordingly their descriptions will not be repeated for the sake of brevity.

Alternatively, at block 2304, the network entity may transmit an RRC configuration to indicate (e.g., report, identify) an SL gap(s) associated with IDC (e.g., selected by, recommended by the network entity) to a wireless communication device (e.g., an Rx UE, such as the Rx UE 1604 as shown and described in connection with FIG. 16). In the example of FIG. 16, the SL gap(s) associated with IDC may be identified as the first IDC Rx UE SL gap(s) and/or the first IDC Tx UE SL gap(s), both in connection with the RRC configuration 1608, for example. For example, the SL gap circuitry 2245 in conjunction with the transceiver 2210 and the antenna array(s) 2221 as shown and described above in connection with FIG. 22 may provide a means to transmit an RRC configuration to report an SL gap(s) associated with IDC to a wireless communication device. Descriptions of the SL gap(s) associated with IDC (including those described in connection with FIG. 16) have been described above, accordingly their descriptions will not be repeated for the sake of brevity.

At block 2306, the network entity may receive an SL UE assistance information, including an SL gap(s) associated with IDC (e.g., selected by, recommended by the wireless communication device) from the wireless communication device (e.g., the Tx UE 1602 as shown and described in connection with FIG. 16). In the example of FIG. 16, the SL gap(s) associated with IDC conveyed via SL UE assistance information may be identified as the second IDC Rx UE SL gap(s) and/or the second IDC Tx UE SL gap(s) in connection with the SL UE assistance information 1614 as shown and described in connection with FIG. 16, for example. According to some aspects, the network entity may additionally receive, via the SL UE assistance information, including an Rx UE SL DRX pattern from the wireless communication device. Descriptions of SL UE assistance information, including an SL DRX pattern or an SL gap(s), has been described above, accordingly their descriptions will not be repeated for the sake of brevity.

At block 2308, the network entity may avoid scheduling grants of resources that overlap with the SL gap(s) associated with IDC (e.g., the second IDC Rx UE SL gap(s) and/or the second IDC Tx UE SL gap(s)). Thereafter, the process 2300 may end.

Alternatively, at block 2310, the network entity may transmit an RRC configuration to indicate (e.g., report, identify) an autonomous denials validity period and maximum number of resources permitted to deny over SL for IDC reasons (e.g., selected by, recommended by the network entity) to a wireless communication device (e.g., an Tx UE, such as the Tx UE 1602 as shown and described in connection with FIG. 16). In the example of FIG. 16, the autonomous denials validity period and maximum number of resources permitted to deny over SL for IDC reasons may be identified as the autonomous denials validity period and maximum number of resources permitted to deny over SL for IDC reasons in connection with the RRC configuration 1618, for example. For example, the autonomous denial of SL circuitry 2246 in conjunction with the transceiver 2210 and the antenna array(s) 2221 as shown and described above in connection with FIG. 22 may provide a means to transmit, or to initiate transmission of an RRC configuration to indicate an autonomous denials validity period and maximum number of resources permitted to deny over SL for IDC reasons. Descriptions of the autonomous denials validity period and maximum number of resources permitted to deny over SL for IDC reasons (including those described in connection with FIG. 16) have been described above, accordingly their descriptions will not be repeated for the sake of brevity.

At block 2312, the network entity may transmit an RRC configuration to configure the wireless communication device to periodically indicate (e.g., periodically transmit a report of, periodically initiate transmission of an indication of) a number (e.g., a quantity) of autonomous denial events that took place over a given period (e.g., selected by, recommended by the network entity) to the wireless communication device (e.g., the Tx UE, such as the Tx UE 1602 as shown and described in connection with FIG. 16). In the example of FIG. 16, the configuration to periodically report the number of autonomous denial events that took place over the given period may be identified in connection with the RRC configuration 1620, for example. For example, the autonomous denial of SL circuitry 2246 in conjunction with the transceiver 2210 and the antenna array(s) 2221 as shown and described above in connection with FIG. 22 may provide a means to transmit, or to initiate transmission of, an RRC configuration to configure the wireless communication device to periodically report a number of autonomous denial events that took place over a given period to the wireless communication device. Descriptions of the RRC configuration that causes the wireless communication device to periodically indicate (e.g., report) the number of autonomous denial events that took place over the given period have been described above, accordingly their descriptions will not be repeated for the sake of brevity.

At block 2314, the network entity may receive periodic indications (e.g., reports) of the number of autonomous denial events that took place over the given period. The periodic indications may be received from the wireless communication device (e.g., the Tx UE, such as the Tx UE 1602 as shown and described in connection with FIG. 16). In the example of FIG. 16, the periodic indications may be identified in connection with block 1622, for example. For example, the autonomous denial of SL circuitry 2246 in conjunction with the transceiver 2210 and the antenna array(s) 2221 as shown and described above in connection with FIG. 22 may provide a means receive periodic indications (e.g., reports) of the number of autonomous denial events that took place over the given period (e.g., from the wireless communication device). Thereafter, the process 2300 may end.

Of course, in the above examples, the circuitry included in the processor 1704 of FIG. 17 and/or the processor 2204 of FIG. 22 are merely provided as examples. Other means for carrying out the described processes or functions may be included within various aspects of the present disclosure, including but not limited to the instructions stored in the computer-readable medium 1706 of FIG. 17 and/or the computer-readable medium 2206 of FIG. 22, or any other suitable apparatus or means described in any one of the FIGS. 1, 2, 3, 5, 6, 8, 10A, 10B, 12, 14A, 14B, 15, and/or 16 and utilizing, for example, the processes and/or algorithms described herein in relation to FIGS. 10A, 10B, 12, 13, 14A, 14B, 15, 16, 18-20, 22, and/or 23.

The following provides an overview of aspects of the present disclosure:

Aspect 1: A first wireless communication device, comprising: a memory; at least one of a first transmitter or a first receiver configured to operate utilizing a first radio access technology (RAT) associated with sidelink communications; at least one of a second transmitter or a second receiver configured to operate utilizing a second RAT, the at least one of the first transmitter or the first receiver and the first RAT being different from the at least one of the second transmitter or the second receiver and the second RAT, respectively; and a processor coupled to the at least one of the first transmitter or the first receiver, the at least one of the second transmitter or the second receiver, and the memory, the processor being configured to: transmit a first signal indicative of a first sidelink (SL) discontinuous reception (DRX) pattern associated with in-device coexistence (IDC) and selected to avoid IDC interference at the first wireless communication device between wireless communications utilizing the first RAT and the second RAT in a given time-frequency resource, receive a second signal indicative of a second SL DRX pattern obtained in view of the first SL DRX pattern in response to transmitting the first signal, and configure the first wireless communication device according to the second SL DRX pattern.

Aspect 2: The first wireless communication device of aspect 1, wherein the first SL DRX pattern is a preferred pattern selected by the first wireless communication device, and the second SL DRX pattern is an indicated pattern received from a device from which the second signal was received.

Aspect 3: The first wireless communication device of aspect 1 or 2, wherein the processor is further configured to: receive a duration of an SL DRX inactivity timer associated with the first SL DRX pattern; and set the SL DRX inactivity timer to the duration in response to receiving a sidelink communication during a first RAT active time, the SL DRX inactivity timer extending the first RAT active time until an expiry of the SL DRX inactivity timer.

Aspect 4: The first wireless communication device of any of aspects 1 through 3, wherein the second SL DRX pattern utilizes time division multiplexing to at least one of: receive utilizing the first RAT on a sidelink communication interface in sidelink licensed spectrum and transmit utilizing the second RAT on a second communication interface, or receive utilizing the first RAT on the sidelink communication interface in sidelink unlicensed spectrum and at least one of: receive or transmit utilizing the second RAT on the second communication interface.

Aspect 5: The first wireless communication device of any of aspects 1 through 4, wherein the processor is further configured to: transmit a sidelink DRX information element including at least a field representative of the first SL DRX pattern.

Aspect 6: The first wireless communication device of any of aspects 1 through 5, wherein the processor is further configured to: report a network interface that is a source of potential in-device coexistence interference.

Aspect 7: The first wireless communication device of any of aspects 1 through 6, wherein the processor is further configured to: transmit a sidelink DRX information element comprising a field representative of a network interface that is a source of potential in-device coexistence interference.

Aspect 8: The first wireless communication device of any of aspects 1 through 7, wherein the processor is further configured to: receive radio resource control (RRC) signaling comprising the second SL DRX pattern from a second wireless communication device or a network entity on a per-resource pool, per-bandwidth part, or per-subchannel basis.

Aspect 9: The first wireless communication device of any of aspects 1 through 8, wherein the first SL DRX pattern is selected to avoid interference by separating, in the time domain, a sidelink related operation associated with the first RAT from at least one of: a non-sidelink related operation associated with the second RAT, or another operation associated with a third RAT, different from the first RAT and the second RAT.

Aspect 10: A method of wireless communication at a first wireless communication device, comprising: transmitting a first signal indicative of a first sidelink (SL) discontinuous reception (DRX) pattern associated with in-device coexistence (IDC) and selected to avoid IDC interference at the first wireless communication device between wireless communications utilizing a first radio access technology (RAT) and a second RAT in a given time-frequency resource; receiving a second signal indicative of a second SL DRX pattern obtained in view of the first SL DRX pattern in response to transmitting the first signal; and configuring the first wireless communication device according to the second SL DRX pattern.

Aspect 11: The method of aspect 10, wherein the first SL DRX pattern is selected by the first wireless communication device, the first SL DRX pattern is a preferred pattern selected by the first wireless communication device, and the second SL DRX pattern is an indicated pattern received from a device from which the second signal was received.

Aspect 12: The method of aspect 10 or 11, further comprising: receiving a duration of an SL DRX inactivity timer associated with a first SL DRX pattern; and setting the SL DRX inactivity timer to the duration in response to receiving a sidelink communication during a first RAT active time, the SL DRX inactivity timer extending the first RAT active time until an expiry of the SL DRX inactivity timer.

Aspect 13: The method of any of aspects 10 through 12, wherein the second SL DRX pattern utilizes time division multiplexing to at least one of: receive utilizing the first RAT on a sidelink communication interface in sidelink licensed spectrum and transmit utilizing the second RAT on a second communication interface, or receive utilizing the first RAT on the sidelink communication interface in sidelink unlicensed spectrum and at least one of: receive or transmit utilizing the second RAT on the second communication interface.

Aspect 14: The method of any of aspects 10 through 13, further comprising:
transmitting a sidelink DRX information element including at least a field representative of the first SL DRX pattern.

Aspect 15: The method of any of aspects 10 through 14, further comprising: reporting a network interface that is a source of potential in-device coexistence interference.

Aspect 16: The method of any of aspects 10 through 15, further comprising: transmitting a sidelink DRX information element comprising a field representative of a network interface that is a source of potential in-device coexistence interference.

Aspect 17: The method of any of aspects 10 through 16, further comprising:
receiving radio resource control (RRC) signaling comprising the second SL DRX pattern from a second wireless communication device or a network entity on a per-resource pool, per-bandwidth part, or per-subchannel basis.

Aspect 18: The method of any of aspects 10 through 17, wherein the first SL DRX pattern is selected to avoid interference by separating, in the time domain, a sidelink related operation associated with the first RAT from at least one of: a non-sidelink related operation associated with the second RAT, or another operation associated with a third RAT, different from the first RAT and the second RAT.

Aspect 19: A first wireless communication device, comprising: a memory; at least one of a first transmitter or a first receiver configured to operate utilizing a first radio access technology (RAT) associated with sidelink communications; at least one of a second transmitter or a second receiver configured to operate utilizing a second RAT, the at least one of the first transmitter or the first receiver and the first RAT being different from the at least one of the second transmitter or the second receiver and the second RAT, respectively; and a processor coupled to the at least one of the first transmitter or the first receiver, the at least one of the second transmitter or the second receiver, and the memory, the processor being configured to: transmit a first signal indicative of at least one of a first periodic sidelink (SL) or a first aperiodic SL gap associated with in-device coexistence (IDC) and selected to avoid IDC interference at the first wireless communication device between wireless communications utilizing the first RAT and the second RAT in a given time-frequency resource, receive a second signal indicative of at least one of a second periodic or a second aperiodic SL gap obtained in view of the at least one of the first periodic SL or the first aperiodic SL gap in response to transmitting the first signal, and configure the first wireless communication device according to the at least one of the second periodic or the second aperiodic SL gap.

Aspect 20: The first wireless communication device of aspect 19, wherein the at least one of the first periodic SL or the first aperiodic SL gap is a preferred SL gap selected by the first wireless communication device, and the at least one of the second periodic or the second aperiodic SL gap is an indicated SL gap received from a device from which the second signal was received.

Aspect 21: The first wireless communication device of aspect 19 or 20, wherein the processor is further configured to: transmit the first signal to a second wireless communication device when operating with the second wireless communication device in sidelink Mode 2.

Aspect 22: The first wireless communication device of any of aspects 19 through 21, wherein the processor is further configured: transmit a value of the at least one of the first periodic SL or the first aperiodic SL gap as sidelink user equipment assistance information (SL UAI) via inter-user equipment (inter-UE) coordination (IUC) signaling with a second wireless communication device.

Aspect 23: The first wireless communication device of any of aspects 19 through 22, wherein the processor is further configured to: transmit a value of the at least one of the first periodic SL or the first aperiodic SL gap as a groupcast.

Aspect 24: The first wireless communication device of any of aspects 19 through 23, wherein the at least one of the first periodic SL or the first aperiodic SL gap is provided on at least one of: a per-resource pool, a per-sidelink bandwidth part, or a per-band basis.

Aspect 25: The first wireless communication device of any of aspects 19 through 24, wherein the first wireless communication device is a sidelink receiving device and operates in sidelink Mode 1, the processor is further configured to: report a value of the at least one of the first periodic SL or the first aperiodic SL gap to a network entity via a sidelink transmitting device.

Aspect 26: The first wireless communication device of aspect 25, wherein the report of the value of the at least one of the first periodic SL or the first aperiodic SL gap is configured by the network entity via radio resource control signaling.

Aspect 27: A wireless communication device, comprising: a memory; at least one of a first transmitter or a first receiver configured to operate utilizing a first radio access technology (RAT) associated with sidelink communications; at least one of a second transmitter or a second receiver configured to operate utilizing a second RAT, the at least one of the first transmitter or the first receiver and the first RAT being different from the at least one of the second transmitter or the second receiver and the second RAT, respectively; and a processor coupled to the at least one of the first transmitter or the first receiver, the at least one of the second transmitter or the second receiver, and the memory, the processor being configured to: receive a configuration that configures the wireless communication device to autonomously deny a sidelink transmission in response to the sidelink transmission prospectively causing in-device coexistence (IDC) interference.

Aspect 28: The wireless communication device of aspect 27, wherein the processor is further configured to: receive a validity period and a maximum number of resources the wireless communication device is enabled to autonomously deny.

Aspect 29: The wireless communication device of aspect 27 or 28, wherein the processor is further configured to: periodically report a quantity of autonomous denial events that take place over a given period via at least one of: a medium access control—control element (MAC-CE), or radio resource control (RRC) signaling.

Aspect 30: The wireless communication device of any of aspects 27 through 29, wherein the wireless communication device operates in sidelink Mode 1.

Aspect 31: A method of wireless communication at a first wireless communication device, the first wireless communication device including at least one of a first transmitter or a first receiver configured to operate utilizing a first radio access technology (RAT) associated with sidelink communications and at least one of a second transmitter or a second receiver configured to operate utilizing a second RAT, the at least one of the first transmitter or the first receiver and the first RAT being different from the at least one of the second transmitter or the second receiver and the second RAT, respectively, the method comprising: transmitting a first signal indicative of at least one of a first periodic sidelink (SL) or a first aperiodic SL gap associated with in-device coexistence (IDC) and selected to avoid IDC interference at the first wireless communication device between wireless communications utilizing the first RAT and the second RAT in a given time-frequency resource, receiving a second signal indicative of at least one of a second periodic or a second aperiodic SL gap obtained in view of the at least one of the first periodic SL or the first aperiodic SL gap in response to transmitting the first signal, and configuring the first wireless communication device according to the at least one of the second periodic or the second aperiodic SL gap.

Aspect 32: The method of aspect 31, wherein the at least one of the first periodic SL or the first aperiodic SL gap is a preferred SL gap selected by the first wireless communication device, and the at least one of the second periodic or the second aperiodic SL gap is an indicated SL gap received from a device from which the second signal was received.

Aspect 33: The method of aspect 31 or 32, further comprising: transmitting the first signal to a second wireless communication device when operating with the second wireless communication device in sidelink Mode 2.

Aspect 34: The method of any of aspects 31 through 33, further comprising: transmitting a value of the at least one of the first periodic SL or the first aperiodic SL gap as sidelink user equipment assistance information (SL UAI) via inter-user equipment (inter-UE) coordination (IUC) signaling with a second wireless communication device.

Aspect 35: The method of any of aspects 31 through 34, further comprising: transmitting a value of the at least one of the first periodic SL or the first aperiodic SL gap as a groupcast.

Aspect 36: The method of any of aspects 31 through 35, wherein the at least one of the first periodic SL or the first aperiodic SL gap is provided on at least one of: a per-resource pool, a per-sidelink bandwidth part, or a per-band basis.

Aspect 37: The method of any of aspects 31 through 36, wherein the first wireless communication device is a sidelink receiving device and operates in sidelink Mode 1, the method further comprising: reporting a value of the at least one of the first periodic SL or the first aperiodic SL gap to a network entity via a sidelink transmitting device.

Aspect 38: The method aspect 37, wherein the reporting of the value of the at least one of the first periodic SL or the first aperiodic SL gap is configured by the network entity via radio resource control signaling.

Aspect 39: A method of wireless communication at a wireless communication device, the wireless communication device including at least one of a first transmitter or a first receiver configured to operate utilizing a first radio access technology (RAT) associated with sidelink communications and at least one of a second transmitter or a second receiver configured to operate utilizing a second RAT, the at least one of the first transmitter or the first receiver and the first RAT being different from the at least one of the second transmitter or the second receiver and the second RAT, respectively, the method comprising: receiving a configuration that configures the wireless communication device to autonomously deny a sidelink transmission in response to the sidelink transmission prospectively causing in-device coexistence (IDC) interference.

Aspect 40: The method of aspect 39, further comprising: receiving a validity period and a maximum number of resources the wireless communication device is enabled to autonomously deny.

Aspect 41: The method of aspect 39 or 40, further comprising: periodically reporting a quantity of autonomous denial events that take place over a given period via at least one of: a medium access control—control element (MAC-CE), or radio resource control (RRC) signaling.

Aspect 42: The method of any of aspects 39 through 41, wherein the wireless communication device operates in sidelink Mode 1.

Aspect 43: An apparatus configured for wireless communication comprising at least one means for performing a method of any one of aspects 10 through 18, 31 through 38, and/or 39 through 42.

Aspect 44: A non-transitory computer-readable medium storing computer-executable code, comprising code for causing an apparatus to perform a method of any one of aspects 10 through 18, 31 through 38, and/or 39 through 42.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-23 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-23 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A first wireless communication device, comprising:
a memory; and
a processor coupled to the memory, the processor being configured to:
initiate transmission of a first signal indicative of a first sidelink (SL) discontinuous reception (DRX) pattern associated with in-device coexistence (IDC) and selected to avoid IDC interference at the first wireless communication device between wireless communications utilizing a first radio access technology (RAT) and a second RAT in a given time-frequency resource, the first RAT being associated with sidelink communications and being different from the second RAT,
receive a second signal indicative of a second SL DRX pattern obtained in view of the first SL DRX pattern in response to the transmission of the first signal, and
configure the first wireless communication device according to the second SL DRX pattern.

2. The first wireless communication device of claim 1, wherein the first SL DRX pattern is a preferred pattern selected by the first wireless communication device, and the second SL DRX pattern is an indicated pattern received from a device from which the second signal was received.

3. The first wireless communication device of claim 1, wherein the processor is further configured to:
receive a duration of an SL DRX inactivity timer associated with the first SL DRX pattern; and
set the SL DRX inactivity timer to the duration in response to receiving a sidelink communication during a first RAT active time, the duration of the SL DRX inactivity timer causing a SL DRX ON duration time associated with a first RAT active time to end before a transmission of a second RAT begins.

4. The first wireless communication device of claim 1, wherein the second SL DRX pattern utilizes time division multiplexing to at least one of:
receive utilizing the first RAT on a sidelink communication interface in sidelink licensed spectrum and transmit utilizing the second RAT on a second communication interface, or
receive utilizing the first RAT on the sidelink communication interface in sidelink unlicensed spectrum and at least one of: receive or transmit utilizing the second RAT on the second communication interface.

5. The first wireless communication device of claim 1, wherein the processor is further configured to:
initiate transmission of a sidelink DRX information element including at least a field representative of the first SL DRX pattern.

6. The first wireless communication device of claim 1, wherein the processor is further configured to:
initiate transmission of an indication of a network interface that is a source of potential in-device coexistence interference.

7. The first wireless communication device of claim 1, wherein the processor is further configured to:
initiate transmission of a sidelink DRX information element comprising a field representative of a network interface that is a source of potential in-device coexistence interference.

8. The first wireless communication device of claim 1, wherein the processor is further configured to:
receive radio resource control (RRC) signaling comprising the second SL DRX pattern from a second wireless communication device or a network entity on a per-resource pool, per-bandwidth part, or per-subchannel basis.

9. The first wireless communication device of claim 1, wherein the first SL DRX pattern is selected to avoid interference by separating, in the time domain, a sidelink related operation associated with the first RAT from at least one of: a non-sidelink related operation associated with the second RAT, or another operation associated with a third RAT, different from the first RAT and the second RAT.

10. A method of wireless communication at a first wireless communication device, comprising:
transmitting a first signal indicative of a first sidelink (SL) discontinuous reception (DRX) pattern associated with in-device coexistence (IDC) and selected to avoid IDC interference at the first wireless communication device between wireless communications utilizing a first radio access technology (RAT) and a second RAT in a given time-frequency resource, the first RAT being associated with sidelink communications and being different from the second RAT;
receiving a second signal indicative of a second SL DRX pattern obtained in view of the first SL DRX pattern in response to transmitting the first signal; and
configuring the first wireless communication device according to the second SL DRX pattern.

11. The method of claim 10, wherein the first SL DRX pattern is selected by the first wireless communication device, the first SL DRX pattern is a preferred pattern selected by the first wireless communication device, and the second SL DRX pattern is an indicated pattern received from a device from which the second signal was received.

12. The method of claim 10, further comprising:
receiving a duration of an SL DRX inactivity timer associated with a first SL DRX pattern; and
setting the SL DRX inactivity timer to the duration in response to receiving a sidelink communication during a first RAT active time, the SL DRX inactivity timer extending the first RAT active time until an expiry of the SL DRX inactivity timer.

13. The method of claim 10, wherein the second SL DRX pattern utilizes time division multiplexing to at least one of:
receive utilizing the first RAT on a sidelink communication interface in sidelink licensed spectrum and transmit utilizing the second RAT on a second communication interface, or
receive utilizing the first RAT on the sidelink communication interface in sidelink unlicensed spectrum and at least one of: receive or transmit utilizing the second RAT on the second communication interface.

14. The method of claim 10, further comprising:
transmitting a sidelink DRX information element including at least a field representative of the first SL DRX pattern.

15. The method of claim 10, further comprising:
transmitting an indication of a network interface that is a source of potential in-device coexistence interference.

16. The method of claim 10, further comprising:
transmitting a sidelink DRX information element comprising a field representative of a network interface that is a source of potential in-device coexistence interference.

17. The method of claim 10, further comprising:
receiving radio resource control (RRC) signaling comprising the second SL DRX pattern from a second wireless communication device or a network entity on a per-resource pool, per-bandwidth part, or per-subchannel basis.

18. The method of claim 10, wherein the first SL DRX pattern is selected to avoid interference by separating, in the time domain, a sidelink related operation associated with the first RAT from at least one of: a non-sidelink related operation associated with the second RAT, or another operation associated with a third RAT, different from the first RAT and the second RAT.

19. A first wireless communication device, comprising:
a memory; and
a processor coupled to the memory, the processor being configured to:
initiate transmission of a first signal indicative of at least one of a first periodic sidelink (SL) gap or a first aperiodic SL gap associated with in-device coexistence (IDC) and selected to avoid IDC interference at the first wireless communication device between wireless communications utilizing a first radio access technology (RAT) and a second RAT in a given time-frequency resource, the first RAT being associated with sidelink communications and being different from the second RAT,
receive a second signal indicative of at least one of a second periodic SL gap or a second aperiodic SL gap obtained in view of the at least one of the first periodic SL or the first aperiodic SL gap, respectively, in response to the transmission of the first signal, and
configure the first wireless communication device according to the at least one of the second periodic SL gap or the second aperiodic SL gap, respectively.

20. The first wireless communication device of claim 19, wherein the at least one of the first periodic SL gap or the first aperiodic SL gap is a preferred SL gap selected by the first wireless communication device, and the at least one of the second periodic SL gap or the second aperiodic SL gap is an indicated SL gap received from a device from which the second signal was received.

21. The first wireless communication device of claim 19, wherein the processor is further configured to:
initiate transmission of the first signal to a second wireless communication device when operating with the second wireless communication device in sidelink Mode 2.

22. The first wireless communication device of claim 19, wherein the processor is further configured:
initiate transmission of a value of the at least one of the first periodic SL gap or the first aperiodic SL gap as sidelink user equipment assistance information (SL UAI) via inter-user equipment (inter-UE) coordination (IUC) signaling with a second wireless communication device.

23. The first wireless communication device of claim 19, wherein the processor is further configured to:
initiate transmission of a value of the at least one of the first periodic SL gap or the first aperiodic SL gap as a groupcast.

24. The first wireless communication device of claim 19, wherein the at least one of the first periodic SL gap or the first aperiodic SL gap is provided on at least one of: a per-resource pool, a per-sidelink bandwidth part, or a per-band basis.

25. The first wireless communication device of claim 19, wherein the first wireless communication device is a sidelink receiving device and operates in sidelink Mode 1, the processor is further configured to:
initiate transmission of an indication of a value of the at least one of the first periodic SL gap or the first aperiodic SL gap to a network entity via a sidelink transmitting device.

26. The first wireless communication device of claim 25, wherein the transmission of the indication of the value of the at least one of the first periodic SL gap or the first aperiodic SL gap is configured by the network entity via radio resource control signaling.

27. A wireless communication device, comprising:
a memory; and
a processor coupled to the memory, the processor being configured to:
receive a configuration that configures the wireless communication device to autonomously deny a sidelink transmission in response to the sidelink transmission prospectively causing in-device coexistence (IDC) interference at the wireless communication device between wireless communications utilizing a first radio access technology (RAT) and a second RAT in a given time-frequency resource, the first RAT being associated with sidelink communications and being different from the second RAT.

28. The wireless communication device of claim 27, wherein the processor is further configured to:
receive a validity period and a maximum number of resources the wireless communication device is enabled to autonomously deny.

29. The wireless communication device of claim 27, wherein the processor is further configured to:
periodically initiate transmission of an indication of a quantity of autonomous denial events that take place over a given period via at least one of: a medium access control—control element (MAC-CE), or radio resource control (RRC) signaling.

30. The wireless communication device of claim 27, wherein the wireless communication device operates in sidelink Mode 1.
